(19) United States
(12) Patent Application Publication
(10) Pub. No.: US 2026/0071044 A1
(43) Pub. Date: Mar. 12, 2026

(54) REPROCESSING CROSSLINKED POLYURETHANE

(71) Applicants: Northwestern University, Evanston, IL (US); BASF SE, Ludwigshafen am Rhein (DE)

(72) Inventors: William R. Dichtel, Evanston, IL (US); Molly Sun, Evanston, IL (US); Jacob Paul Brutman, Dearborn, MI (US); Alaaeddin Alsbaiee, Novi, MI (US)

(21) Appl. No.: 19/105,735

(22) PCT Filed: Aug. 22, 2023
(86) PCT No.: PCT/US2023/072686

§ 371 Date: Feb. 21, 2025

Related U.S. Application Data
(60) Provisional application No. 63/373,197, filed on Aug. 22, 2022.

(51) Int. Cl. C08J 11/06; C08J 11/10; C08K 5/00

(52) U.S. Cl. CPC C08J 11/06; C08J 11/10; C08K 5/0091; C08J 2201/03; C08J 2375/12

(57) ABSTRACT

Disclosed herein are methods and composition for reprocessing crosslinked polyurethanes. The method may comprise mechanically processing the crosslinked polyurethane, mixing the mechanically processed crosslinked polyurethane with a solid polyurethane exchange catalyst, heating the mixture to an effective bond-exchange temperature, and applying mechanical force to the mixture for an effective bond-exchange time. In another aspect the method may comprise heating a polyurethane exchange catalyst and an antioxidant composition, the antioxidant composition comprising the crosslinked polyurethane and an antioxidant, to an effective bond-exchange temperature and applying mechanical force to the polyurethane exchange catalyst and the antioxidant composition for an effective bond-exchange time.

### CROSS-REFERENCE TO RELATED APPLICATIONS

This application claims benefit of priority to U.S. Patent Application 63/373,197, filed Aug. 22, 2022, the contents of which is incorporated by reference in its entirety.

### STATEMENT REGARDING FEDERALLY SPONSORED RESEARCH

This invention was made with government support under DE-EE0007897 awarded by the Department of Energy, and CHE1901635, DMR1121262, and DGE1842165 awarded by the National Science Foundation. The government has certain rights in the invention.

### BACKGROUND OF THE INVENTION

Many cross-linked polymers are not recyclable. Incorporating dynamic covalent bonds into polymer networks can lead to materials that possess mechanical properties competitive with traditional static thermosets while displaying recyclability commonly associated with thermoplastics. Many dynamic covalent bonds, including imines, boronic esters, disulfides, and reversible Diels-Alder adducts have been incorporated into cross-linked polymer networks and been shown to enable their reprocessing. Although these approaches will potentially enable new technologies or sustainable reuse of cross-linked materials, these linkages are uncommon in commodity polymers such as polyurethanes (PUs).

Polyurethanes (PUs) are the sixth largest class of polymers used worldwide, and are commonly used in cross-linked architectures as foams, adhesives, coatings, and structural components. The direct bulk reprocessing of PUs into similar value materials is not well-developed. Due to their large scale use, much work has focused on the repurposing or recycling of cross-linked PU waste, although most approaches rely on chemical recycling via glycolysis to produce new PU polyol oligomers or blending with thermoplastic polymers. Incorporation of other dynamic bonds into PUs is one strategy to directly recycle these cross-linked materials. Currently, few methods exist for recycling PU on an industrially viable scale, and methods that propose using dibutyltin dilaurate (DBTDL) to reprocess polyurethane are effective, but DBTDL is a toxic compound with documented health concerns. A green catalyst that can perform rapid polyurethane bond exchange is needed to reduce these toxicity concerns and render these reprocessing methods industrially viable. Another strategy is to control the dynamic nature of urethane linkages to enable recycling of these materials on large scale.

### BRIEF SUMMARY OF THE INVENTION

Disclosed herein are methods and composition for reprocessing crosslinked polyurethanes. In a first aspect, the method may comprise mechanically processing the crosslinked polyurethane, mixing the mechanically processed crosslinked polyurethane with a solid polyurethane exchange catalyst, heating the mixture to an effective bond-exchange temperature, and applying mechanical force to the mixture for an effective bond-exchange time. The crosslinked polyurethane may comprise a network polymer formed from an isocyanate constitutional unit and a second constitution unit having a hydroxyl group capable of reacting with an isocyanate group of the isocyanate constitutional unit to form a urethane bond. Suitably, the crosslinked polyurethane is mechanically processed with the solid polyurethane exchange catalyst. The crosslinked polyurethane may be combined with an antioxidant prior to, during, or after mechanical processing. The disclosed technology allows for solvent-free reprocessing of the crosslinked polyurethane, including crosslinked polyurethane foams. Additionally, the disclosed technology allows for reprocessing of the crosslinked polyurethane with lower polyurethane exchange catalyst loadings compared to methods of permeating the polyurethane exchange catalyst within the crosslinked polyurethane.

The solid polyurethane exchange catalyst may comprise Zr, Bi, Fe, Ti, Hf, Al, Zn, Cu, Ni, Co, Mn, V, Sc, Y, Ce, Mo, or Sn and a ligand coordinated with the metal atom. In some embodiments, the solid polyurethane exchange catalyst comprises Zr. Suitably, the solide polyurethane exchange catalyst is Zr(acac)₄ or Zr(tmdh)₄. In some embodiments, the solid polyurethane exchange catalyst is free of tin. The mechanically processed crosslinked polyurethane may be mixed with less than 5 mol % solid polyurethane exchange catalyst per carbamate.

Mechanically processing the crosslinked polyurethane may comprise milling the crosslinked polyurethane. The crosslinked polyurethane may be mechanically processed at a temperature below room temperature, e.g., less than 20° C. In some embodiments, the crosslinked polyurethane may be mechanically processed at a temperature below room temperature between-200° C. and 0° C.

The method may optionally comprise a drying step prior to heating to the effective bond-exchange temperature. The mixture may be dried under vacuum at a drying temperature prior to heating the mixture to the effective bond-exchange temperature to remove adventitious water.

Another aspect of the invention provides for compositions for use in the disclosed methods comprising a mechanically processed crosslinked polyurethane and a solid polyurethane exchange catalyst. The solid polyurethane exchange catalyst may comprise Zr, Bi, Fe, Ti, Hf, Al, Zn, Cu, Ni, Co, Mn, V, Sc, Y, Ce, Mo, or Sn and a ligand coordinated with the metal atom. In some embodiments, the solid polyurethane exchange catalyst comprises Zr. Suitably, the solide polyurethane exchange catalyst is Zr(acac)₄ or Zr(tmdh)₄. In some embodiments, the solid polyurethane exchange catalyst is free of tin. The mechanically processed crosslinked polyurethane may be mixed with less than 5 mol % solid polyurethane exchange catalyst per carbamate.

In another aspect the method may comprise heating a polyurethane exchange catalyst and an antioxidant composition, the antioxidant composition comprising the crosslinked polyurethane and an antioxidant, to an effective bond-exchange temperature and applying mechanical force to the polyurethane exchange catalyst and the antioxidant composition for an effective bond-exchange time. In some embodiments, the antioxidant is tris(nonylphenyl) phosphite. In some embodiments, the polyurethane exchange catalyst may be a solid and mixed with the polyurethane composition prior to heating to the effective bond-exchange temperature. In some embodiments, a polyurethane exchange catalyst solution comprising the polyurethane exchange catalyst is permeated within the crosslinked composition polyurethane prior to heating to the effective bond-exchange temperature. The polyurethane exchange catalyst may comprise Zr, Bi, Fe, Ti, Hf, Al, Zn, Cu, Ni, Co, Mn, V, Sc, Y, Ce, Mo, or Sn and a ligand coordinated with the metal atom. In some embodiments, the polyurethane exchange catalyst comprises Zr. Suitably, the solide polyurethane exchange catalyst is Zr(acac)₄ or Zr(tmdh)₄. In some embodiments, the polyurethane exchange catalyst is free of tin.

Another aspect of the invention provides for compositions for use in the disclosed methods comprising a crosslinked polyurethane, an antioxidant, and a polyurethane exchange catalyst. The polyurethane exchange catalyst may comprise Zr, Bi, Fe, Ti, Hf, Al, Zn, Cu, Ni, Co, Mn, V, Sc, Y, Ce, Mo, or Sn and a ligand coordinated with the metal atom. In some embodiments, the polyurethane exchange catalyst comprises Zr. Suitably, the polyurethane exchange catalyst is Zr(acac)₄ or Zr(tmdh)₄. In some embodiments, the polyurethane exchange catalyst is free of tin. In some embodiments, the crosslinked polyurethane is mechanically processed and mixed with less than 5 mol % polyurethane exchange catalyst per carbamate. Optionally, the polyurethane exchange catalyst is a solid.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1 shows the general scheme for reprocessing polyester polyurethane networks using catalysts, such as Zr(acac)₄ or Zr(tmhd)₄.

FIG. 2 shows (A) a general scheme for casting polyester polyurethane films; (B) FT-IR (attenuated total reflectance) spectra of MDI and crosslinked films cured using either DBDTL or Zr(acac)₄ catalysts; and (C) DMTA of crosslinked films cured using either DBDTL or Zr(acac)₄ catalysts.

FIG. 3 shows stress relaxation analysis data for films containing (A) DBDTL and (B) Zr(acac)₄ catalysts at 0.25, 0.50, or 1.0 mol % relative to carbamate linkages.

FIG. 4 shows the general scheme for reprocessing polyester polyurethane foams.

FIG. 5 shows stress relaxation analysis data for reprocessed foams containing variable quantities of catalyst corresponding to DBTDL, Zr(acac)₄, and Zr(tmhd)₄.

FIG. 6 shows images of polyester polyurethane films reprocessed through multiple cycles, DMTA data for films reprocessed through multiple continuous cycles, and tensile data for films reprocessed through multiple continuous cycles.

FIG. 7 shows commercial materials reprocessed with DBTDL and Zr-based catalyst and corresponding SRA curves.

FIG. 8 shows stress relaxation analysis data of sample with 2 mol % Zr(acac)₄ post-introduced through cryogenic milling.

FIG. 9 shows differential scanning calorimetry corresponding to polyester PU films synthesized with 0.5 wt % TNPP and 1 mol % DBTDL or 1 mol % Zr(acac)₄ catalyst.

FIG. 10 shows images of polyester PU films synthesized with 0.5 wt % TNPP and 0.25, 0.35, 0.50, 0.75, or 1.0 mol % Zr(tmhd)₄, from top left to bottom right.

FIG. 11 shows FT-IR of MDI and polyester PU foam with 0.5% TNPP.

FIG. 12 shows differential scanning calorimetry of polyester PU foam containing 0.5 wt % TNPP.

FIG. 13 Polyester PU foam with no TNPP reprocessed with DBTDL, Zr(acac)₄, or Zr(tmhd)₄ post-introduced at 30 mg/mL from left to right. Note poor material quality without TNPP, including inhomogeneity, brittleness, and macroscopic tears. Filaments are approximately 4 mm wide and 1 mm thick.

FIG. 14 shows FT-IR of polyester PU foam with 0.5% TNPP reprocessed with Zr(acac)₄ for five continuous cycles. Increasing quantity of urea can be observed through the growth of the corresponding peak at 1642 cm⁻¹ as indicated by the dashed grey line.

FIG. 15 shows FT-IR of polyester PU foam with 0.5% TNPP reprocessed with Zr(acac)₄ for five continuous cycles. Increasing quantity of urea can be observed through the growth of the corresponding peak at 1642 cm⁻¹ as indicated by the dashed grey line.

FIG. 16 shows images of polyester PU foam cryogenically milled with 2 mol % Zr(acac)₄ and reprocessing of the resulting powder into films. Films were successfully reprocessed for four continuous cycles.

FIG. 17 shows Dynamic mechanical thermal analysis of sample with 2 mol % Zr(acac)₄ post-introduced through cryogenic milling.

FIG. 18 shows differential scanning calorimetry comparing polyester PU foam reprocessed with Zr(acac)₄ introduced through solvent-assisted means, reprocessed with 2 mol % Zr(acac)₄ introduced by cryomilling, and pristine PU film material.

### DETAILED DESCRIPTION OF THE INVENTION

The reprocessing or recycling of cross-linked polymers by incorporating dynamic covalent cross-links has the potential to increase the sustainability associated with using these materials. Polyurethanes (PUs) are the largest class of polymers commonly used in cross-linked form; however, their direct recycling into similar value materials is not well-developed. The Examples demonstrate that a variety of Lewis acid catalysts can mediate the exchange of urethane bonds selectively and at relatively mild conditions. Incorporating these catalysts into cross-linked polyether and polyester PUs gives cross-linked materials that relax stress very rapidly. Due to their dynamic nature, these polymers can be reprocessed, for example, via compression molding to give materials with similar cross-linking densities, despite their covalently cross-linked architecture.

Covalent adaptable networks (CANs) provide a pathway to achieving these sustainability goals. CANs are polymer networks with linkages that undergo dynamic exchange, enabling them to be reshaped at elevated temperatures or through other stimuli, while maintaining the desirable properties of the material at its service temperatures.⁶⁻⁹ Several functional groups give rise to dynamic networks, including esters,⁹ boronate esters,¹⁰⁻¹³ Diels-Alder adducts,^{14,15} carbonates,¹⁶ disulfides,^{17,18} siloxanes,^{19,20} urethanes,²¹⁻²³ and others,^{5,7} many of which use external catalysts blended into the network. For PUs, carbamate exchange can be enabled by a catalyst at temperatures >140° C. through methods such as compression molding, extrusion, and reaction injection molding.²³⁻²⁵ Organotin compounds, including DBTDL are neurotoxic, teratogenic, and environmentally toxic.²⁶⁻²⁸ For CANs, the catalyst will often be embedded throughout the material's lifetime, making it even more important that it be safe and environmentally benign. Exemplary PU reprocessing methods have been disclosed in U.S. Ser. No. 17/050,138, U.S. Pat. No. 17,605,831, PCT/US2023/063276, and PCT/US2023/066028, which are incorporated by reference in their entireties for all purposes.

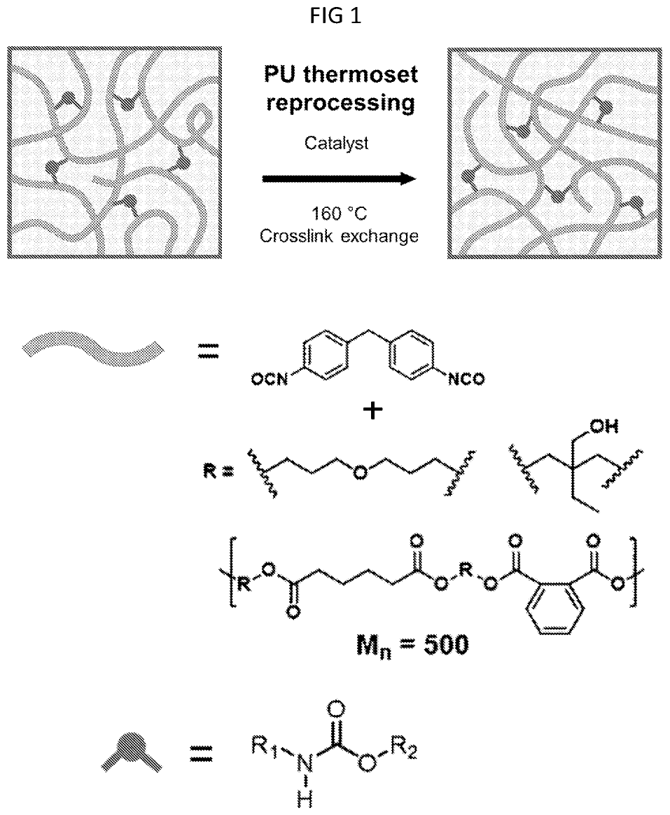

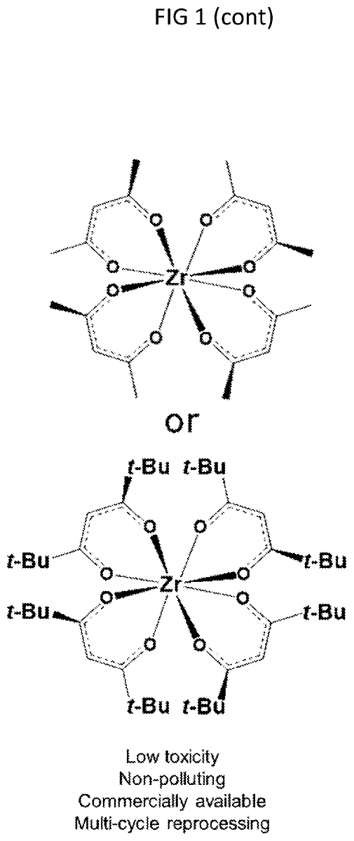

Here, we demonstrate the use of non-tin Lewis acidic catalysts, such as zirconium acetylacetonate [Zr(acac)₄],³³ and zirconium tetrakis(2,2,6,6-tetramethyl-3,5-heptanedionate) [Zr(tmhd)₄]³⁴, to reprocess PU thermosets (FIG. 1). Here both synthesized and commercial thermoset PUs were infiltrated with these catalysts. The catalysts may be introduced from solution at high loading, which gives rise to reprocessable networks upon extrusion at elevated temperatures. Lewis acidic catalysts facilitate carbamate exchange and enable scalable recycling processes for PU waste. The disclosed catalysts are capable of reprocessing PU foam up to four cycles, and dynamic mechanical thermal analysis indicates zirconium-based catalysts can preserve glass transition temperature and crosslink density between cycles. Therefore, non-tin catalysts, such as the disclosed zirconium catalysts, are suitable green catalysts for bulk reprocessing of thermoset PU plastics.

Further a solvent-free method is disclosed that allows for low catalyst loadings. Additionally, these solvent free methods allow for the elimination of solvent from the reprocessing workflow. Crosslinked polyurethane may be mechanically processed, such as through cryogenic milling. Solid polyurethane exchange catalyst may be introduced with the crosslinked polyurethane before, during, or after crosslinked polyurethane is mechanically processed. When the solid polyurethane exchange catalyst is introduced before or during mechanical processing, the crosslinked polymer and catalyst may be mixed during mechanical processing.

Several definitions are provided to assist with the understanding of the technology.
“Antioxidant” means an additive that protects polymers against oxidation by controlling molecular weight changes that lead to a loss of physical, mechanical, and optical properties. Antioxidants may work by scavenging free radicals that are formed when polymers are exposed to elevated temperature and/or oxygen. Antioxidants may be classified in two categories. Primary antioxidants that react with free radicals such as *OH and *OR to form inactive produces, such as water and alcohols. Examples of primary antioxidants include sterically hindered phenols. Secondary antioxidants react with hydroperoxides to form inactive products, such as alcohols. Examples of secondary antioxidants include phosphites. Use of antioxidants may allow for superior physical properties of the reprocessed PU. A composition comprising a PU and an antioxidant may be referred to an antioxidant composition. For example, samples that lacked an antioxidant in some instances could not be characterized due to macroscopic tears in the samples. An exemplary antioxidant is tris(nonylphenyl) phosphite (TNPP).
“Block” means a portion of a macromolecule, comprising many constitutional units, that has at least one constitutional or configurational feature which is not present in the adjacent portions.
“Branch” means an oligomeric or polymeric offshoot from a macromolecular chain.
“Branch point” means a point on a chain at which a branch is attached.
“Branch unit” means a constitutional unit containing a branch point.
“Catalyst” means a substance that increases the rate of a reaction without modifying the overall Gibbs energy change in the reaction. Suitably the catalyst may be a coordination entity comprising a central atom and one or more ligands joined to the central atom. Suitably the central atom is a metal. “Ligand” means an atom or group joined to a central atom.
“Chain” means a whole or part of a macromolecule, an oligomer molecule, or a block, comprising a linear or branched sequence of constitutional units between two boundary constitutional units, each of which may be either an end-group, a branch point, or an otherwise-designated characteristic feature of the macromolecule.
“Compounding” means to blend or mix a substance, such as any of the polyurethane compositions described herein, within a compounding device. Suitably the substance is compounded at an effective bond-exchange temperature for an effective bond-exchange time.
“Compounding device” means a device for blending or mixing a substance, such as any of the polyurethane compositions described herein. In some embodiments, the compounding device is an extruder, such as a single screw or twin-screw extruder, a mixer, or a kneader. Suitably twin-screw extruders may be a co-rotating or counter-rotating twin-screw extruder. The compounding device may operate in batch or continuous service. Suitably a continuous service compound device may have an inlet, such as a feeding hopper or other suitable feeding mechanism, for introducing the substance into the compounding device, an outlet for extruding the compounded substance, and a compounding zone between the inlet and the outlet for mixing or blending the substance. Suitably the compounding zone is configured so that the substance may be compounded for an effective bond-exchange time. The compounding device may also comprise a heating element so that the substance may be compounded at an effective bond-exchange temperature.
“Constitutional unit” means an atom or group of atoms (with pendant atoms or groups, if any) comprising a part of the essential structure of a macromolecule, an oligomer molecule, a block, or a chain.
“Covalent network” or “covalent polymer network” means a network in which the permanent paths through the structure are all formed by covalent bonds.
“Dynamic network” or “dynamic polymer network” means a covalent network that is capable undergoing bond-exchange reactions at a temperate above an effective bond-exchange temperature. A dynamic network may demonstrate viscoelastic liquid properties above the freezing transition temperature.
“Effective amount of a polyurethane exchange catalyst” means an amount of polyurethane exchange catalyst necessary for the urethane-bond exchange reactions to occur within an effective bond-exchange time at an effective bond-exchange temperature. In some embodiments, the effective amount of polyurethane exchange catalyst allows for an effective-bond exchange time less than or equal to 12 minutes at an effective bond-exchange temperature less than or equal to 160° C. In some embodiments, the mol % of the polyurethane exchange catalyst to the total carbamate functionality may be less than or equal to 5 mol %. Suitably, the mol % may be less than or equal 4 mol %, 3 mol %, 2 mol %, 1 mol %, or less than 1 mol %. Some materials may contain small amounts of residual catalyst from their manufacture, often 0.1 mol % or less. Such limited quantities of catalyst are typically not enough to enable dynamic bond exchange on a practical time scale. As a result, the effective amount of polyurethane exchange catalyst may be increased post-synthetically by the methods described herein such as swelling or direct mechanical mixing.
“Effective bond-exchange temperature” means a temperature above the freezing transition temperature. The “freezing transition temperature” is the temperature where a material transitions from a viscoelastic solid to a viscoelastic liquid. The effective bond-exchange temperature is lower than the temperature where the dynamic network undergoes irreversible thermal instability or degradation. In some embodiments, the effective bond-exchange temperature is greater than the freezing transition temperature and less than or equal to 275° C. Suitably the effective bond-exchange temperature may be greater than the freezing transition temperature and less than or equal to 250° C., 225° C., 200° C., 190° C., 180° C., 170° C., 160° C., 150° C., 140° C., 130° C., 120° C., 110° C., or less than 110° C. In some embodiments, the effective bond-exchange temperature is between 110° C. and 275° C., 140° C. and 275° C., 150° C. and 250° C., 160° C. and 250° C., or 170° C. and 225° C. In some instances, it may be beneficial to dry a substance comprising crosslinked polyurethane under vacuum prior to heating the substance to the effective bond-exchange temperature. Drying may remove water that can react with free isocyanates during reprocessing. Substances may be dried at a temperature between 25° C. and 100° C. Drying may occur over a suitable period. For example, the substance may be dried for a period of between 2 and 48 hours, 2 and 36 hours, 2 and 24 hours, or 2 and 12 hours. The vacuum is at a pressure less than atmospheric pressure. For example, the vacuum may be a rough vacuum (e.g., between about 1000 and 1 mbar), medium vacuum (e.g., between 1 and 10⁻³ mbar), or high vacuum (e.g., between 10⁻³ and 10⁻⁷ mbar).
“Effective bond-exchange time” means a time sufficient for urethane-bond exchange reactions to occur. The effective bond-exchange time may be determined by monitoring the stress decay of a polyurethane composition. Suitably, a minimum effective bond-exchange time may be determined as the time necessary for the stress relaxation modulus to relax to at least 37% (1/e) of its initial value. In some embodiments, the effective bond-exchange time is less than or equal to 60 minutes. Suitably the effective bond-exchange time may be less than 50 minutes, 45 minutes, 40 minutes, 35 minutes, 30 minutes, 25 minutes, 20 minutes, 15 minutes, 12 minutes, 10 minutes, or less than 10 minutes.
“Foam” means a multiphasic material comprising gas dispersed in a polymer. The foam may be formed by trapping pockets of gas in a solid or liquid. Foams may be prepared by physical or chemically blowing. In some embodiments, the foam may be a closed-cell foam where the gas forms discrete, completely surrounded pockets. In other embodiments, the foam may be an open-cell foam where the gas pockets are interconnected. Suitably the polymer is a polyurethane (“polyurethane foam”).
“Inorganic polymer” means a polymer or polymer network with a skeletal structure that does not include carbon atoms. Examples include, without limitation, polyphosphazenes, polysilicates, polysiloxanes, polysilanes, polysilazanes, polygermanes, and polysulfides.
“Isocyanate constitutional unit” means a constitutional unit comprising at least one isocyanate group, i.e., —NCO. Suitably the isocyanate constitutional unit may comprise more than one isocyanate group such as two, three, four, or more than four isocyanate groups. The isocyanate constitutional unit may be a prepolymer molecule or a branch unit. Suitably the second constitutional unit may function as both a prepolymer molecule and a branch unit. In some embodiments, the isocyanate constitutional unit is an aromatic isocyanate constitutional unit. As used herein, an “aromatic isocyanate constitutional unit” means an isocyanate constitutional unit having an isocyanate group pendant from an aryl group such a phenyl or other aromatic ring. In other embodiments, the isocyanate constitutional unit is an aliphatic isocyanate constitutional unit. As used herein, an “aliphatic isocyanate constitutional unit” means an isocyanate constitutional unit having an isocyanate group pendant from an aliphatic group such an acyclic or cyclic alkyl, an acyclic or cyclic alkenyl, or an acyclic or cyclic alkynyl group.
“Lewis acid” means a molecular entity (and the corresponding chemical species) that is an electron-pair acceptor and therefore able to react with a Lewis base to form a Lewis adduct, by sharing the electron pair furnished by the Lewis base.
“Linear chain” means a chain with no branch points between the boundary units.
“Macromolecule” or “polymer molecule” means a molecule of high relative molecular mass, the structure of which essentially comprises the multiple repetition of units derived, actually or conceptually, from molecules of low relative molecular mass.
“Mechanically processed” means to mechanically alter a substance, e.g., by mechanically milling, grinding, cutting, chopping, or applying some other form of mechanical force. Suitably, the substance such as the polyurethane compositions described herein may be mechanically processed to fragment the substance into pieces or grains. For example, crosslinked polyurethanes may be cryogenically milled, which may be referred to as cryomilled. Cryogenically milled means to reduce the crosslinked polyurethane to pieces or grains at a temperature below room temperature, e.g., 20° C. When cryogenically milling, the substance or chamber containing the substance may be cooled by any suitable cooling medium. The Examples demonstrate the use of liquid nitrogen, but other cooling mediums such as refrigerants, dry ice, or ice water may be used. Suitably, the crosslinked polyurethane may be cryogenically milled at a temperature between −200° C. and 0° C. The temperature may be determined by controlling the cooling medium selected. For Example, the crosslinked polyurethane may be cryogenically milled at a temperature of about-200° C., −180° C., −160° C., −140° C., −120° C., −100° C., −80° C., −60° C., −40° C., −20° C., 0° C., or any range therebetween. During mechanical processing of the crosslinked polyurethane, a solid polyurethane exchange catalyst may be mixed with the mechanically processed crosslinked polyurethane. In other embodiments, a solid polyurethane exchange catalyst may be mixed with the mechanically processed crosslinked polyurethane after mechanical processing.
“Monomer” means a substance composed of monomer molecules.
“Monomer molecule” means a molecule which can undergo polymerization, thereby contributing constitutional units to the essential structure of a macromolecule.
“Monomeric unit” means the largest constitutional unit contributed by a single monomer molecule to the structure of a macromolecule or oligomer molecule.
“Network” means a highly ramified macromolecule in which essentially each constitutional unit is connected to each other constitutional unit and to the macroscopic phase boundary by many permanent paths through the macromolecule, the number of such paths increasing with the average number of intervening bonds; the paths must on the average be co-extensive with the macromolecule.
“Network polymer” means a polymer composed of one or more networks.
“Oligomer molecule” means a molecule of intermediate relative molecular mass, the structure of which essentially comprises a small plurality of units derived, actually or conceptually, from molecules of lower relative molecular mass.
“Organic polymer” means a polymer or polymer network with a skeletal structure that includes carbon atoms. Examples include, without limitation, polyethers, polyesters, polycarbonates, polyacrylates, polyolefins, and polybutadienes.
“Polymer” means a substance composed of macromolecules.
“Polymerization” means a process of converting a monomer or a mixture of monomers into a polymer.
“Prepolymer molecule” means a macromolecule or oligomer molecule capable of entering, through reactive groups, into further polymerization, thereby contributing more than one constitutional unit to at least one type of chain of the final macromolecules.
“Polyurethane composition” means a dynamic network formed from urethane bonds that are capable of undergoing urethane bond-exchange reactions. The polyurethane compositions comprise a network urethane-containing polymer and a polyurethane exchange catalyst permeated within or mixed with the network polymer. The network polymer may be formed from isocyanate constitutional units and a second constitutional unit having hydroxyl groups capable of reacting with the isocyanate group of the isocyanate constitutional unit. The mol % of the polyurethane exchange catalyst to the total carbamate functionality may be less than or equal to 5 mol %. Suitable, the mol % may be less than or equal 4 mol %, 3 mol %, 2 mol %, 1 mol %, or less than 1 mol %. The second constitutional unit may be a prepolymer molecule or a branch unit. Suitably the second constitutional unit may function as both a prepolymer molecule and a branch unit. The prepolymer molecule is an organic polymer molecule or an inorganic polymer molecule such as a polyether, a polyester, a polycarbonate, a polyacrylate, a polyolefin, a polybutadiene, a polysulfide, or a polysiloxane having one or more hydroxyl groups capable of reacting with an isocyanate group. When the prepolymer molecule also functions as a branch unit, the prepolymer molecule has a three or more hydroxyl groups capable of reacting with isocyanate groups and typically a plurality of hydroxyl groups in proportion to the number of constitutional units of the prepolymer molecule. The network polymer may also be formed from urethane-containing monomers featuring other polymerizable groups, including but not limited to, acrylates, methacrylates, or other polymerizable olefins.
“Polyurethane exchange catalyst” means a catalyst that increases the rate of a polyurethane bond-exchange reaction. In some embodiments, the polyurethane bond-exchange reaction is a carbamate-exchange reaction. Suitable metal for the catalyst include Sn, Bi, Fe, Zr, Ti, Hf, Al, Zn, Cu, Ni, Co, Mn, V, Sc, Y, Ce, or Mo. In some embodiments, the metal is Zr. Suitable ligands for the catalyst include carboxylate, alkoxide, 1,3-diketone, 1,2-diketone, trifluoromethanesulfonate, trifluoromethanesulfonamide, amido, sulfonate, halide, catecholate, phosphine, salicylidene diamine, carbonate, phosphate, nitrate, cyclopentadiene, pyridine, hydroxide, or any combination thereof. Exemplary ligands include acetylacetonate (acac), isopropoxide (OiPr), neodecanoate (neo), laurate, ethylhexanoate, and 2,2,6,6-Tetramethyl-3,5-heptanedione (tmhd). Exemplary catalysts include, without limitation, dibutyltin dilaurate (DBTDL), Bi(neo)₃, Fe(acac)₃, Ti(OiPr)₂(acac)₂, Hf(acac)₄, Zr(acac)₄, Mn(acac)₂, Bi(oct)₃, Zn(tmhd)₂, Zr(tmhd)₄, or any combination thereof.
“Subchain” means an arbitrarily chosen contiguous sequence of constitutional units, in a chain.
“Thermosetting polymer” or “thermoset” is a polymer that is irreversibly hardened by curing from a soft solid of viscous liquid prepolymer or resin.
“Vitrimer” means a network polymer that can change its topology by thermally activated bond-exchange reactions. At elevated temperatures, the bond-exchange reactions occur at an effectively rapid rate and the network polymer has properties of a viscoelastic liquid. At low temperatures, the bond-exchange reactions are slowed and the network polymer behaves like a thermosetting polymer.

Unless otherwise specified or indicated by context, the terms “a”, “an”, and “the” mean “one or more.” For example, “a molecule” should be interpreted to mean “one or more molecules.”

As used herein, “about”, “approximately,” “substantially,” and “significantly” will be understood by persons of ordinary skill in the art and will vary to some extent on the context in which they are used. If there are uses of the term which are not clear to persons of ordinary skill in the art given the context in which it is used, “about” and “approximately” will mean plus or minus ≤10% of the particular term and “substantially” and “significantly” will mean plus or minus >10% of the particular term.

As used herein, the terms “include” and “including” have the same meaning as the terms “comprise” and “comprising.” The terms “comprise” and “comprising” should be interpreted as being “open” transitional terms that permit the inclusion of additional components further to those components recited in the claims. The terms “consist” and “consisting of” should be interpreted as being “closed” transitional terms that do not permit the inclusion additional components other than the components recited in the claims. The term “consisting essentially of” should be interpreted to be partially closed and allowing the inclusion only of additional components that do not fundamentally alter the nature of the claimed subject matter.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent applications, and patents, cited herein are hereby incorporated by reference to the same extent as if each reference were individually and specifically indicated to be incorporated by reference and were set forth in its entirety herein.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

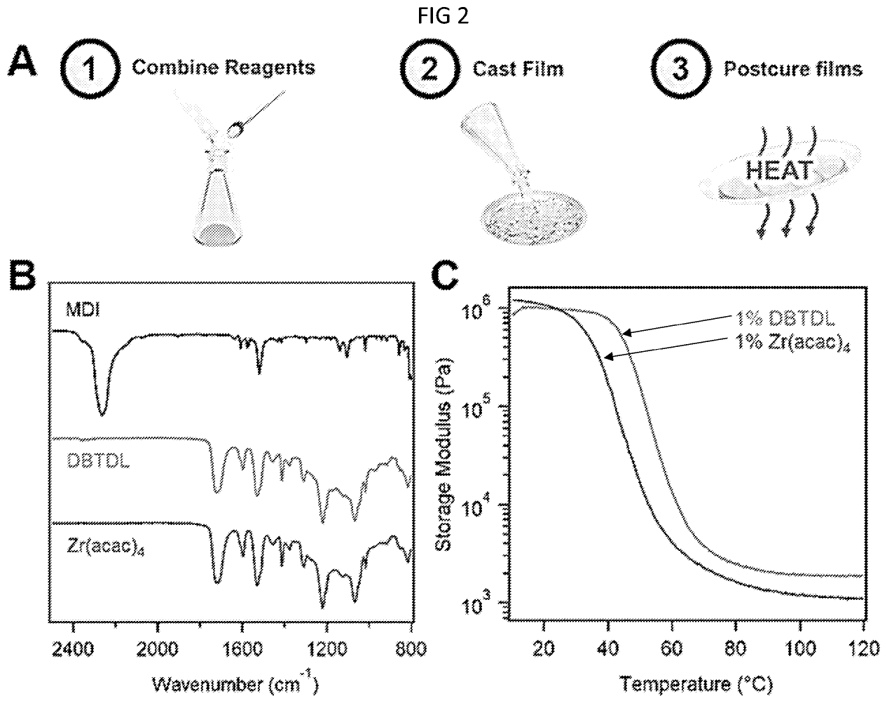

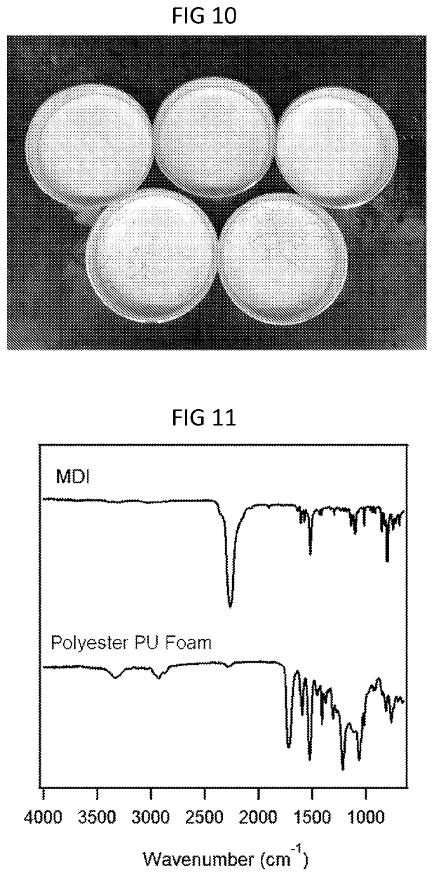

To determine whether Zr-based catalysts were viable candidates for reprocessing PU foams, Zr(acac)₄ was first used to catalyze PU film formation, where it successfully produced crosslinked PU networks suitable for reprocessing (FIG. 2A). These Zr(acac)₄-containing films were therefore first produced with no other external catalysts to allow their stress relaxation to be characterized. Later, these catalysts were introduced to already prepared PUs to simulate a recycling process, so no efforts were made to optimize its properties as a polymerization catalyst. Thermoset PU films in this study were synthesized from methylene diphenyl diisocyanate (MDI) and poly [trimethylolpropane/di(propylene glycol)-alt-adipic acid/phthalic anhydride] polyol (f=2.5), a commercially available polyester polyol (polyol 1). Tris(nonylphenyl) phosphite (Tnpp), a common commercial antioxidant additive, was also added at 0.5 wt % to mitigate PU degradation. DBTDL or Zr(acac)₄ catalyst were directly incorporated into the films during synthesis at 0.25, 0.50, and 1.0 mol % per carbamate. All components were dissolved in 20 mL of DCM, cast in aluminum pans, and post-cured in a vacuum oven at 90° C. for 48 hours to produce translucent, light-yellow films. Control films containing 0.5 wt % Tnpp with no catalyst were also synthesized using a similar procedure, in which film components were dissolved in dry toluene, cast into a pan, and cured at 60° C. Both DBTDL and Zr(acac)₄ resulted in fully crosslinked PU films (FIG. 2a). Fourier-transform infrared spectroscopy (FT-IR) shows that after the post-cure step, the isocyanate stretch at 2285 cm⁻¹ disappears and a carbamate stretch around 1708-1724 cm⁻¹ appears, indicating that the PU network is crosslinked (FIG. 2B). Furthermore, dynamic thermal mechanical analysis (DMTA) for films synthesized with DBTDL gave a 72 of 35° C., whereas films synthesized with Zr(acac)₄ had a T_{g} of 45° C. (FIG. 2C). Through differential scanning calorimetry (DSC), the T_{g} of PU film synthesized with DBTDL was 28° C., and the T_{g} of the PU film synthesized with Zr(acac)₄ was 34° C. (FIG. 9). The gel fractions for these samples were 82% and 77%, respectively, indicative of a crosslinked material. Although films incorporating Zr(tmhd)₄ were also prepared, they were brittle and unsuitable for further characterization (FIG. 10), despite Zr(tmhd)₄ proving to be a viable reprocessing catalyst in later experiments (see below). These data indicate that both catalysts provide cross-linked networks that enable further dynamic processes to be evaluated.

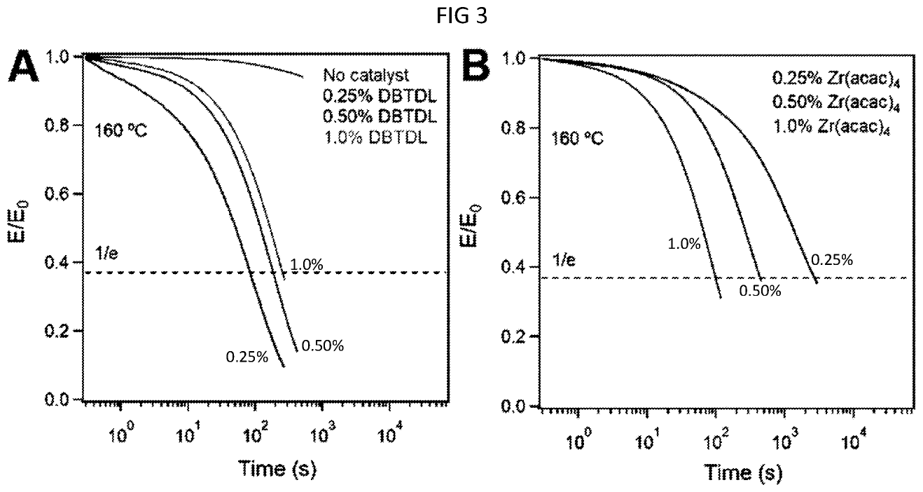

Stress relaxation analysis (SRA) indicated that Zr(acac)₄ is an effective exchange catalyst in the solid polymers, suggesting it may be suitable to replace DBTDL. At 160° C., SRA performed on films containing 0.25, 0.50, and 1.0 mol % (relative to the exchangeable carbamate bonds) DTBTL provided characteristic stress relaxation times (τ*) of 148 s, 114 s, and 72 s, respectively (FIG. 3A). The 0.25, 0.50, and 1.0 mol % Zr(acac)₄ corresponding τ* were 2724 s, 443 s, and 100 s, respectively (FIG. 3B). These τ* values indicate that Zr(acac)₄ is a competent catalyst to mediate urethane exchange and stress relaxation. Control films that contained 0.5 wt % Tnpp but no catalyst did not exhibit significant stress relaxation, only displaying a 6% drop in storage modulus after 1000 s, which confirms that the antioxidant does not mediate carbamate exchange under these conditions. These studies indicate the promise of Zr(acac)₄ as a urethane reprocessing catalyst, which we next evaluated by introducing the catalyst to already prepared PU foams.

Reprocessing PU Foams with Catalysts Introduced from Solution

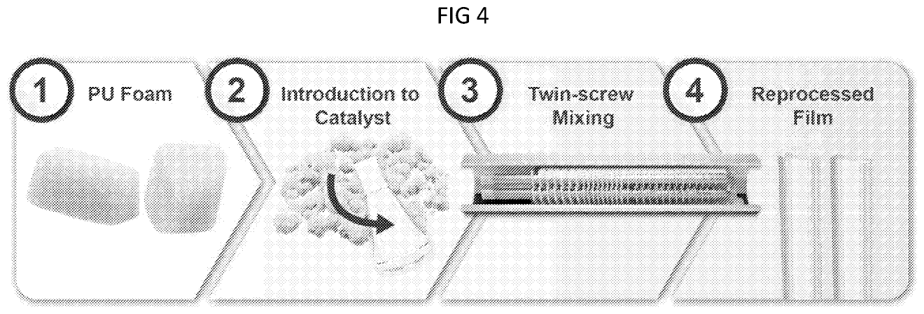

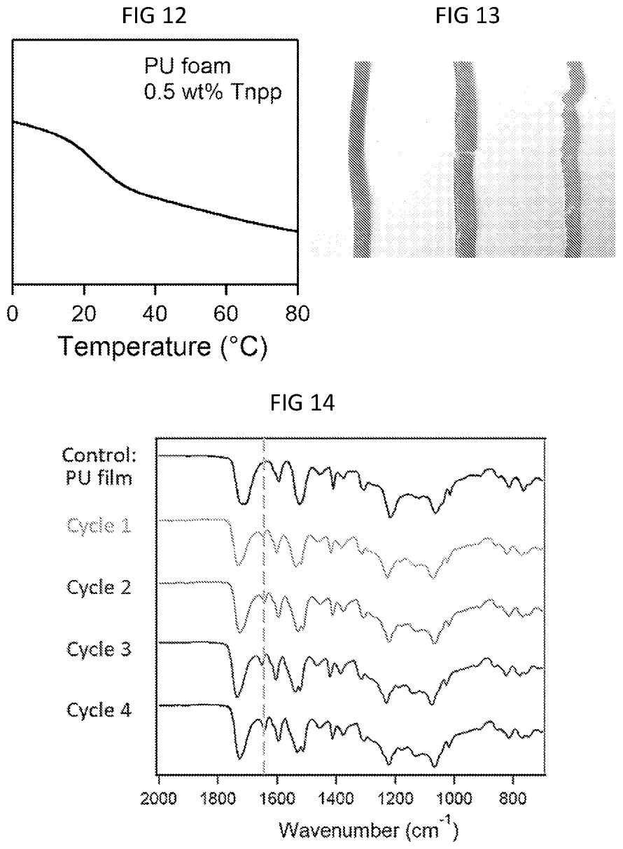

Methods to introduce catalysts and reprocess PU foams will be important to enable post-consumer PU reprocessing. Zr(acac)₄ and Zr(tmhd)₄ are both amenable for this purpose and can be introduced to reprocess thermoset PU foam through twin-screw extrusion (FIG. 4). Model PU foams were prepared from the same monomers as above, and isopentane was used as a physical blowing agent (see SI for detailed procedures). FT-IR spectroscopy of the foam and its gel fraction percentage of 90% were consistent with the formation of crosslinked networks with the expected chemical composition, indicating that the PU networks were cured (FIG. 11). DSC indicated a glass transition temperature (T_{g}) of 23° C. (FIG. 12). Zr catalysts were introduced to PU foam through a solvent-assisted process and compared to analogous samples produced with DBTDL. Ground PU foam (100 mg/mL) was added to CH₂Cl₂ solutions of DBTDL, Zr(acac)₄, or Zr(tmhd)₄ at catalyst concentrations of 10, 20, or 30 mg/mL. The suspensions were stirred for 24 h, filtered, and dried under vacuum to remove excess solvent. The resulting dried polymers were analyzed by inductively coupled plasma-optical emission spectroscopy (ICP-OES) to determine catalyst loading from the solution-based procedure. PU foams that were suspended in 30 mg/mL DBTDL contained 1.76 wt % Sn, whereas foams exposed to Zr(acac)₄ solution contained 0.11 wt % Sn and 3.1 wt % Zr. Foams exposed to Zr(tmhd)₄ solutions had 0.10% Sn and 1.3% Zr. These relatively high Zr loadings indicate that foams uptake catalyst from solution, absorbing anywhere from 38% to 87% of Zr catalyst originally present in the solution (Table 6). Though this solvent-assisted catalyst incorporation method results in foams with high catalyst loadings, foams with lower catalyst loadings were prepared through a solvent-free cryogenic milling process described below.

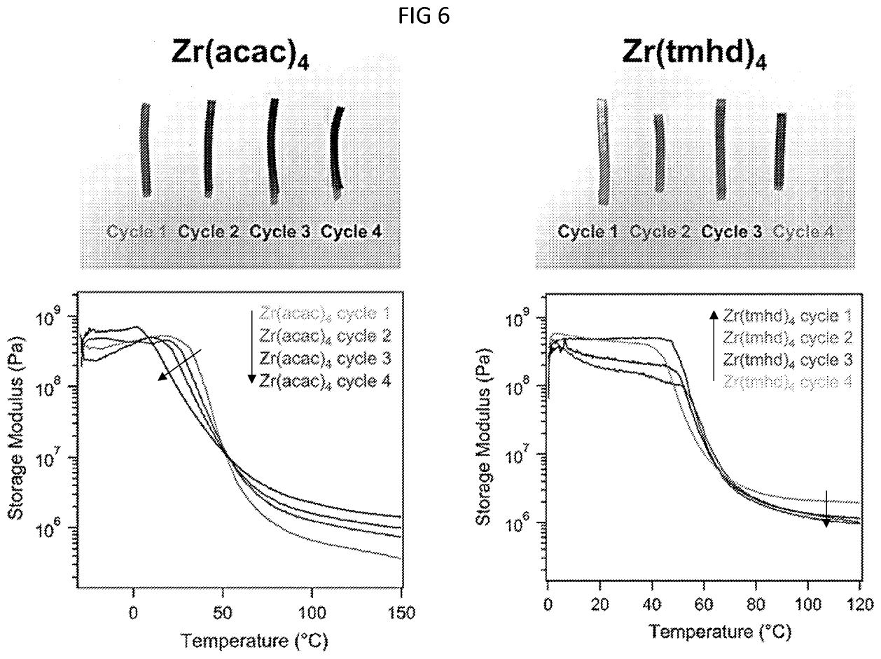

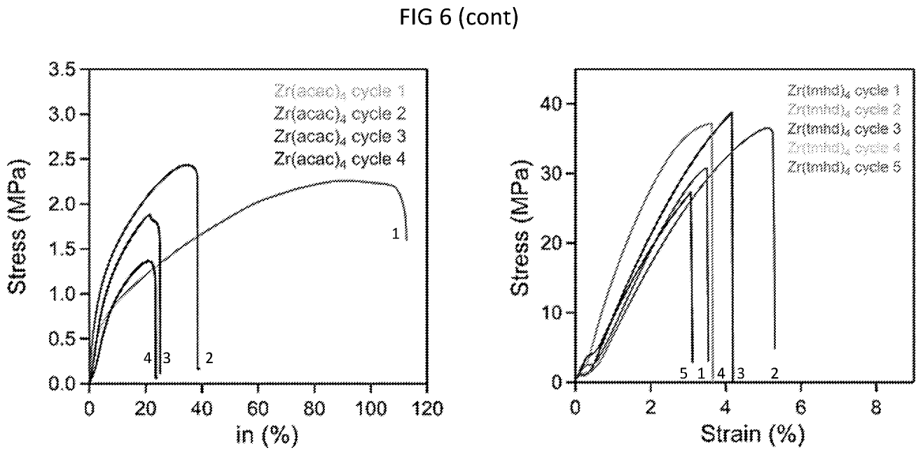

Catalyst-containing foams were reprocessed using twin-screw extrusion at 200° C., and samples containing added DBDTL, Zr(acac)₄, and Zr(tmhd)₄ each provided continuous extrudates of sufficient quality to characterize their thermomechanical properties. Foams that incorporated the antioxidant TNPP in their original polymerization provided the highest quality samples, which were characterized rigorously. Samples that lacked TNPP could not be characterized due to macroscopic tears in the samples (FIG. 14). The reprocessed foams were passed through the extruder once, corresponding to a residence time of about 1 minute. The extrudate was collected as homogenous, light yellow, and continuous filament with a rectangular cross-section derived from the die (FIG. 6). PU foam without additional catalyst, but having only the residual tin from its polymerization, was extruded as a control. Although this control foam partially fused under the extrusion conditions, the extrudate was inhomogeneous and discolored, with obvious macroscopic tears, indicating that additional catalyst is necessary for reprocessing under these conditions. Together, these findings indicate that Zr(acac)₄ and Zr(tmhd)₄ are both potential replacements for DBDTL for PU foam reprocessing, which motivated a more careful study of the thermomechanical properties of these samples.

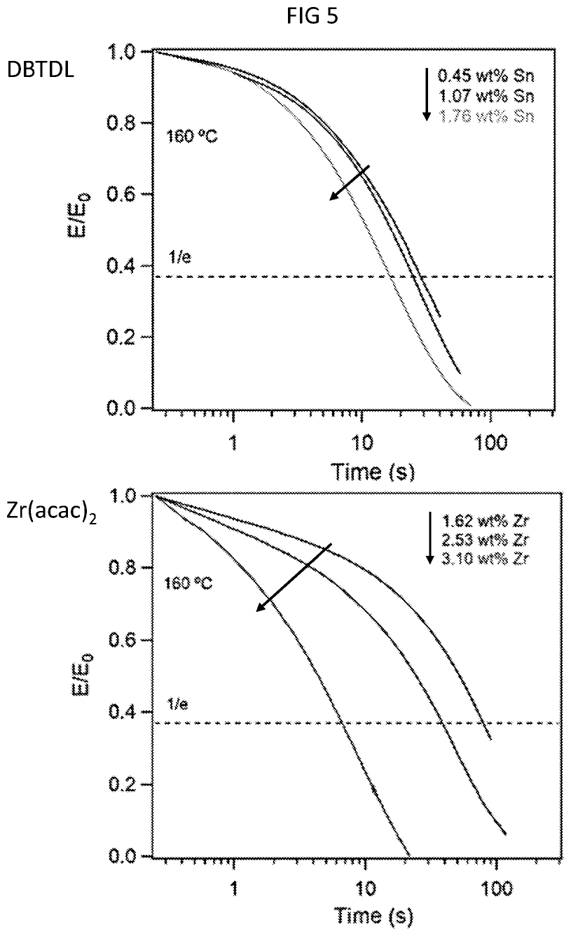

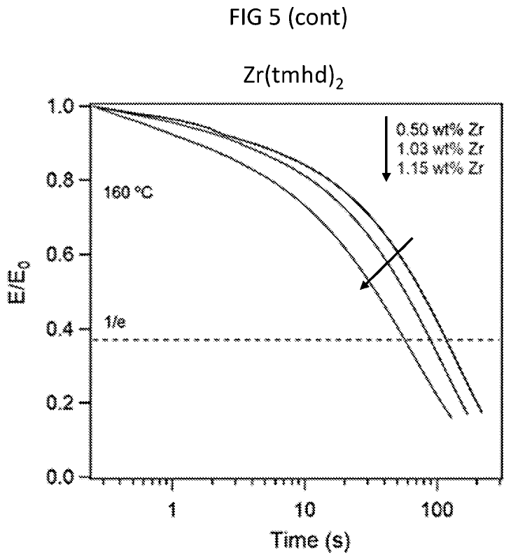

Both Zr-based catalysts produced reprocessed PUs with desirable thermomechanical properties, even outperforming DBTDL under some conditions through SRA. SRA of the extrudates at 160° C. indicate that both Zr catalysts facilitate dynamic carbamate exchange on rapid timescales (FIG. 5 and Table 1). Generally, higher catalyst loading correlated to shorter τ* times, and samples reprocessed with both Zr catalysts exhibit τ* values of less than 2 minutes. Therefore, both Zr(acac)₄ and Zr(tmhd)₄ are capable of performing rapid carbamate exchange and are viable candidates as reprocessing catalysts. Zr(acac)₄ gives rise to a fast τ* time under 10 s, which may also arise from its high catalyst loading from the solution-based method. In contrast, cryogenically milled samples that contain lower quantities of Zr(acac)₄ exhibit a τ* time that is slower but still less than 2 min (see below). Based on extrudate quality and SRA analysis, foam samples containing 0.5% Tnpp with the highest Zr catalyst loadings produced the highest performing materials, so these conditions were carried into further testing with continuous reprocessing experiments.

### Evaluating Multiple Reprocessing Cycles Using Zr-Based Catalysts

TABLE 1
τ* times of reprocessed thermoset polyester PU at 160° C.

| Catalyst solution | Sn | DBTDL τ* | Zr | Zr(acac)₄ τ* | Zr | Zr(tmhd)₄ τ* |
|---|---|---|---|---|---|---|
| concentration (mg/mL) | wt %^{a} | (s) | wt % | (s) | wt % | (s) |
| 10 mg/mL | 0.45 | 29 | 1.62 | 79 | 0.50 | 119 |
| 20 mg/mL | 1.07 | 25 | 2.53 | 39 | 1.03 | 90 |
| 30 mg/mL | 1.76 | 17 | 3.10 | 6.8 | 1.27 | 58 |

^{a}For samples containing DBTDL, values for Sn % reflect the cumulative amount of DBTDL both used for synthesizing PU foam and introduced after the foam synthesis. For samples containing Zr(acac)₄ or Zr(tmhd)₄, small quantities of Sn are still present from foam synthesis (see Table 6).

To further explore the potential of Zr-based PU reprocessing catalysts, multiple reprocessing cycle experiments with Zr-based catalysts were performed to assess the potential catalyst lifetimes and their continuous use in PU material. Dynamic PU networks were reprocessed through three repeat cycles through compression molding, both with and without the addition of additional catalyst.^{21,43-45} However, reprocessing of PU networks through twin-screw extrusion operations has not been well-studied. Therefore, catalyst-containing foam samples were reprocessed at 200° C. and 50 rpm for as many cycles as possible until PU material degraded past characterizable quality. Since 30 mg/mL catalyst post-introduction concentration conditions yielded the fastest exchange kinetics, samples produced with these conditions were used. Extrudates from the preceding cycle were cut into pieces, fed back through the cleaned extruder, and recollected for further reprocessing cycles.

With these conditions, samples containing Zr(acac)₄ can be reprocessed up to four cycles, and samples containing Zr(tmhd)₄ can be reprocessed up to five cycles—the latter with less network degradation than samples containing Zr(acac)₄. For both types of catalyst samples, extrudates darkened in color during later reprocessing cycles (FIG. 6). SRA results indicate that for both Zr catalysts, catalyst efficacy and the rate of carbamate exchange generally decreases as the number of reprocessing cycles increase (Figures S10-S11 and Table 2). For Zr(acac)₄, τ* times steadily increase from 19 s to 69 s by the fourth reprocessing cycle. For Zr(tmhd)₄, this stress relaxation trend is less clear: while τ* was 49 s for the first reprocessing cycle, τ* was in the 20-30 s range for the second, third, and fourth reprocessing cycles. However, τ* increased to 46 seconds by the fifth reprocessing cycle, indicating some network degradation occurs during extended continuous reprocessing. DMTA results indicate that the T_{g} of Zr(acac)₄ samples decreases from 27° C. to 9° C. (FIG. 6), and the crosslink density increases as the number of reprocessing cycles increase, from 0.095 mol/cm³ in the first reprocessing cycle to 0.51 mol/cm³ in the last reprocessing cycle (Table 7). For Zr(tmhd)₄ samples, T_{g} and crosslinking density of Zr(tmhd)₄ samples remain consistent until the last reprocessing cycle, in which the Ta decreases from about 52-55° C. to 46° C. (FIG. 6) and the crosslink density increases from about 0.23-0.29 mol/cm³ to 0.48 mol/cm³ (Table 7). Through DSC, the T_{g} of samples reprocessed with Zr(acac)₄ decreased from 14° C. to 3.1° C., and the T_{g} of samples reprocessed with Zr(tmhd)₄ decreased from 50° C. to 34° C. range (Table 7). The presence of urea and increase in cross-linking density with both catalysts could potentially be attributed a combination of network degradation through urea formation or currently unidentified side reactions, especially in samples containing Zr(acac)₄. While the exact contribution that side reactions impart to network degradation merits further study, it is likely that hydrolysis of the PU network is one of the primary causes of this degradation.

TABLE 2
τ* times and T_{g} temperatures for
continuously reprocessed PU samples.

| | Zr(acac)₄ τ* | Zr(tmhd)₄ τ* | Zr(acac)₄ T_{g} | Zr(tmhd)₄ T_{g} |
|---|---|---|---|---|
| Cycle # | time (s) | time (s) | (° C.) | (° C.) |
| 1 | 19 | 49 | 27 | 52 |
| 2 | 24 | 27 | 33 | 55 |
| 3 | 56 | 26 | 21 | 52 |
| 4 | 69 | 29 | 8.7 | 46 |
| 5 | — | 46 | — | — |

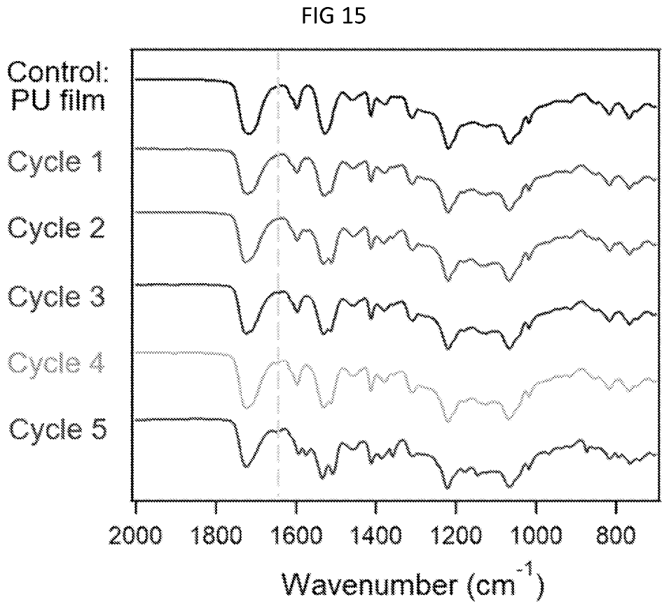

The presence of ureas in reprocessed samples may be attributed to the build-up of free amines generated by hydrolysis of isocyanates in the PU network.¹ Evidence for urea formation was observed in FTIR spectra of reprocessed samples, which sometimes exhibited a resonance at 1642 cm⁻¹.⁴⁶ Samples reprocessed with Zr(acac)₄ all exhibited elevated urea signals, but samples reprocessed with Zr(tmhd)₄ only showed evidence for urea formation after three or more reprocessing cycles, and this signal remains modest through cycles four and five (FIG. 15). Samples loaded with less concentrated Zr(acac)₄ solutions also showed reduced tendency to form ureas, with none observed by FT-IR after the first reprocessing cycle (FIG. 14). Overall, both catalysts are capable of multiple reprocessing cycles. Polyester PU materials reprocessed with Zr(acac)₄ exhibit with faster stress relaxation times, but polyester PU reprocessed with Zr(tmhd)₄ exhibit greater resistance to degradation, especially urea formation in the network. It must be noted that this degradation appears to be accentuated by particularly high catalyst loadings, especially for samples reprocessed with Zr(acac)₄. As a result, lower catalyst loadings are more desirable, and loadings as low as 2 mol % attained through cryogenic milling are shown to be reprocessable below. Properties of lower catalyst containing PU foam and its potential degradation are also discussed later below.

Sustained degradation of material with increased reprocessing is corroborated by tensile testing results, especially for samples reprocessed with Zr(acac)₄. Samples reprocessed with Zr(acac)₄ exhibit low stresses at break and high strains at break, and both values decrease as number of reprocessing cycles increase (Table 3). From the first to the last reprocessing cycle, average stress at break decreases from 2.5 MPa to 1.5 MPa, and strain at break decreases from 102% to 24%. Consequently, Young's modulus increases from 2.3 MPa to 6 MPa. In contrast, samples reprocessed with Zr(tmhd)₄ exhibit high stresses at break and low strains at break, and both values generally remain constant as number of reprocessing cycles increase (Table 4). The average stress at break is 30 MPa for the first reprocessing cycle and 29 MPa for the last reprocessing cycle. The strain at break is 3.9 MPa for the first reprocessing cycle and 3.2 MPa for the last reprocessing cycle. Young's modulus gradually increases 0.5 MPa for the first reprocessing cycle to 0.9 MPa for the last reprocessing cycle. When compared to each other, samples reprocessed with Zr(acac)₄ appear to behave more like an elastomeric material even though the original material is a crosslinked thermoset. This transition is consistent with loss of crosslink density in these materials, which is corroborated by gel fraction results.

While samples reprocessed with DBTDL and Zr(tmhd)₄ have gel fractions of 89% and 92% respectively, samples reprocessed with Zr(acac)₄ had gel fractions of 47%. It should be noted that the T_{g} of Zr(acac)₄ samples is around RT, and since tensile tests were conducted at RT, there may be variability in tensile properties measured at that temperature. Since Zr(acac)₄ exhibits high strains about 400% at elevated temperature (40° C.) in combination with low stress at break, samples reprocessed with Zr(acac)₄ exceeded instrument limitations above T_{g}. Ultimately, tensile testing results indicate that samples reprocessed with Zr(acac)₄ undergo sustained degradation and acquire properties more consistent with elastomeric materials, and samples reprocessed with Zr(tmhd)₄ more closely match properties associated with glassier, highly crosslinked materials.

TABLE 3
Tensile testing results for samples reprocessed
with Zr(acac)₄ over multiple cycles.

| Reprocessing | Average stress | Average strain | Average Young's |
|---|---|---|---|
| cycle | at break (MPa) | at break (%) | modulus (MPa) |
| 1 | 2.45 ± 0.23 | 102.82 ± 9.60 | 2.27 ± 0.40 |
| 2 | 2.37 ± 0.30 | 34.35 ± 7.57 | 7.09 ± 0.89 |
| 3 | 2.26 ± 0.29 | 35.81 ± 9.35 | 6.59 ± 1.03 |
| 4 | 1.45 ± 0.24 | 24.18 ± 3.04 | 5.95 ± 0.30 |

TABLE 4
Tensile testing results for samples reprocessed
with Zr(tmhd)₄ over multiple cycles.

| Reprocessing | Average stress | Average strain | Average Young's |
|---|---|---|---|
| cycle | at break (MPa) | at break (%) | modulus (GPa) |
| 1 | 30.04 ± 8.77 | 3.48 ± 0.63 | 0.491 ± 0.063 |
| 2 | 38.03 ± 3.93 | 5.29 ± 0.23 | 0.721 ± 0.090 |
| 3 | 39.08 ± 7.82 | 4.21 ± 0.70 | 0.942 ± 0.070 |
| 4 | 35.30 ± 1.97 | 3.55 ± 0.80 | 1.024 ± 0.080 |
| 5 | 28.89 ± 5.11 | 3.16 ± 0.64 | 0.919 ± 0.064 |

To further expand the scope of this reprocessing method, both Zr catalysts were also tested on commercial polyester and polyether PU materials, which resulted in successful foam-to-film reprocessing. Following the same foaming procedure used previously, polyester PU foam was produced with Lupraphen 6601 polyol (diol, MW=˜2000 g/mol) and Lupranate M20 isocyanate (f=2.7). Polyether foam was produced with Pluracol 2090 (triol, MW=4800 g/mol) and MDI. All foams were synthesized with 0.5 wt % Tnpp, and FT-IR indicated that synthesis of these foams were successful. The disappearance of the isocyanate stretch around 2285 cm⁻¹ and appearance of a carbamate stretch around 1708-1724 cm⁻¹ indicated that the PU network was completely cured (Figures S16-S17). These polymers were subjected to the same solution-based catalyst introduction procedure described above. DBTDL, Zr(acac)₄, and Zr(tmhd)₄ catalysts were all tested on both the polyester PU and polyether PU. For the polyester PU, 30 mg/mL was an appropriate solution concentration, whereas the polyether PU provided a low viscosity, non-extrudable liquid even at 10 mg/mL solution concentration. Therefore, catalyst was lowered to 3 mg/mL. Although Zr(acac)₄ was able to partially reprocess the polyether PU, it did not result in fully homogenous, characterizable material (FIG. 5). ICP-OES indicated that following solvent-assisted catalyst post-introduction, commercial polyester PU foam with Zr(acac)₄ contained 0.70% Sn and 1.86% Zr, commercial polyester PU foam with Zr(tmhd)₄ contained 0.28% Sn and 0.07% Zr, and commercial polyether PU foam with Zr(tmhd)₄ foam contained 0.02% Sn and 0.87% Zr. All samples contained less than 0.01% P. Compared to non-commercial PU foams tested in this study, commercial PU foams absorbed less catalyst but still had relatively high catalyst loadings.

Reprocessing Commercial Polyurethanes Using Zr-Based Catalysts Introduced from Solution

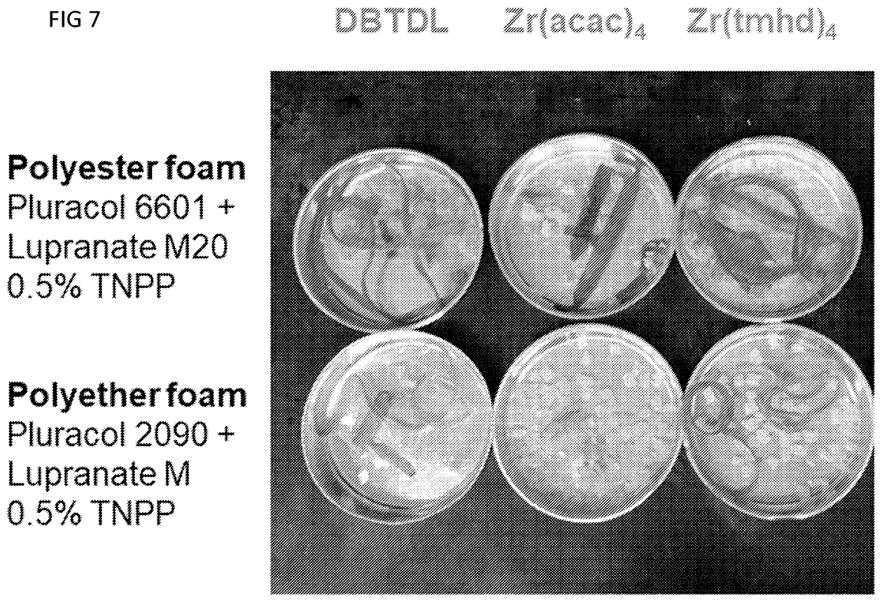

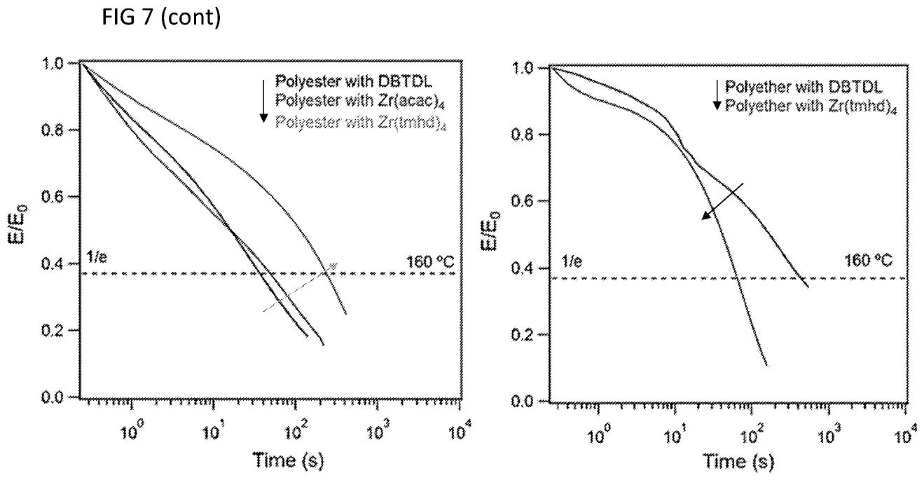

Once reprocessing parameters were optimized, SRA suggested that (FIG. 7) both Zr-based compounds catalyzed carbamate exchange similarly to DBTDL. For the commercial polyester PU, Zr(acac)₄ introduced at a concentration of 30 mg/mL had a τ* of 50 s, and Zr(tmhd)₄ post-introduced at a concentration of 30 mg/mL had a τ* of 38 s. In the polyether PU, Zr(tmhd)₄ post-introduced at a concentration of 30 mg/mL had a τ* of 162 s, and DBTDL post-introduced at a concentration of 30 mg/mL had a τ* of 442 s (Table 5). Therefore, both Zr(acac)₄ and Zr(tmhd)₄ catalysts facilitate rapid carbamate exchange in these commercial PU at desirable reprocessing conditions. DMTA for corresponding samples show that polyester PU samples reprocessed with Zr(acac)₄ has a T_{g} of −35° C., polyester PU samples reprocessed with Zr(tmhd)₄ has a T_{g} of −37° C., and polyether PU samples reprocessed with Zr(acac) has a T_{g} of −57° C., and it is generally expected that the polyether PU sample has a lower T_{g} than polyester PU. Overall, both Zr catalysts serve as suitable green reprocessing catalysts in both model materials and commercial materials with potential for industrial use.

TABLE 5
τ* times of reprocessed thermoset BASF PU at 160° C.

| | | | |
|---|---|---|---|
| Loading (mg/mL) | DBTDL τ* (s) | Zr(acac)₄ τ* (s) | Zr(tmhd)₄ τ* (s) |

Polyester PU

| | | | |
|---|---|---|---|
| 30 mg/mL | 38 | 50 | 241 |

Polyether PU

| | | | |
|---|---|---|---|
| 30 mg/mL | 442 | N/A | 162 |

### Reprocessing Polyurethanes Using Lower Catalyst Amounts and Solventless Catalyst Incorporation

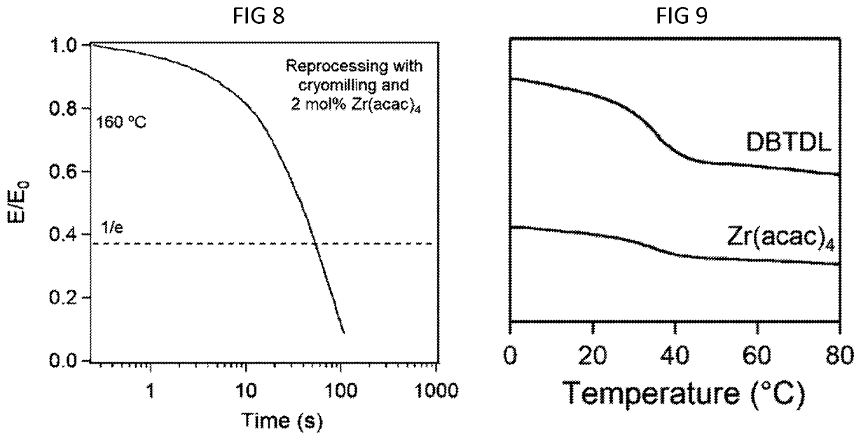

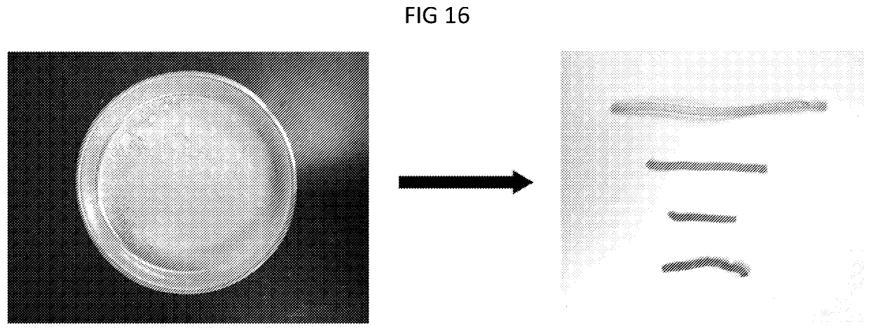

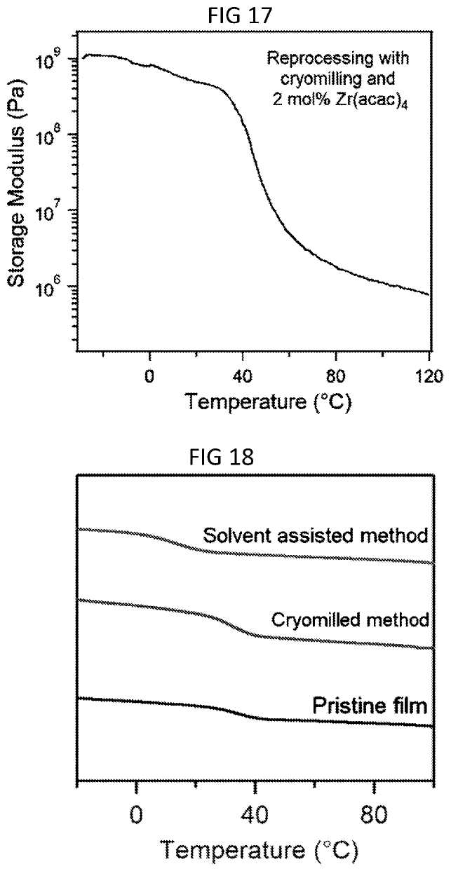

Although PU foams uptake catalyst from solvent, lower catalyst loadings as low as 2 mol % catalyst per carbamate are attainable through cryogenic milling, where materials are cooled to below room temperature and mechanically ground into fine, homogenous powder. Solid catalyst was directly added to PU foam when loading in the cryogenic mill, allowing for precise control of catalyst content. Reprocessing experiments were repeated with model foams containing 2 mol % Zr(acac)₄, which corresponds to 3 wt % Zr(acac)₄. Once prepared and dried under vacuum at 90° C. overnight, cryogenically ground catalyst-containing powder was reprocessed through the same twin-screw extrusion methods used previously, resulting in clear, homogenous yellow-brown extrudates similar to those previously produced with the solvent-assisted catalyst post-introduction method (FIG. 16). When comparing PU samples that incorporated different Zr(acac)₄ introduction methods, cryogenic milling was able to controllably introduce Zr(acac)₄ to PU foam at lower loadings than the solvent-assisted method. Samples with Zr(acac)₄ introduced through solvent-assisted methods consisted of 16.6 wt % catalyst or 13.5 mol % catalyst per carbamate while samples with Zr(acac)₄ post-introduced through cryogenic milling consisted of 2.9 wt % catalyst or 2 mol % catalyst per carbamate. SRA results indicated that cryogenically milled low catalyst-containing samples have a higher τ* time of 54 s, compared to 19 s with solvent-assisted samples, but these samples are still capable of rapid stress relaxation at elevated temperatures (FIG. 8). DMTA results indicate that even with lower catalyst loadings, samples produced with both catalyst post-introduction methods possess similar properties. Samples produced through the solvent-assisted method had a T_{g} of 33° C., and samples produced through cryogenic milling had a T_{g} of 47° C. through DMTA (FIG. 17 and Table 8). Through DSC, samples produced through the solvent-assisted method had a T_{g} of 14.0° C., and samples produced through cryogenic milling had a 7% of 32° C. (FIG. 18 and Table 8). Differences in material properties between the two types of samples may be attributed to differences in catalyst loading and possible partial degradation of the PU feedstock.⁴⁷

### CONCLUSIONS

Developing scalable PU recycling methods is vital for reducing the millions of tons of PU waste produced each year, especially thermoset PU waste. In this work, catalysts were identified as appropriate green catalysts for twin-screw extrusion and bulk reprocessing of thermoset polyester PU. These Zr catalysts produced high-quality, homogenous extrudates, both with model PU materials and commercial PU materials. Following SRA characterization, these Zr catalysts were found to perform dynamic carbamate exchange on par with DBTDL. Furthermore, these Zr catalysts can continuously reprocess model PU materials up to 4-5 cycles. Though model PU networks degrade as reprocessing cycles increase, SRA, DMTA, FT-IR, and tensile testing characterization confirmed that materials reprocessed with Zr(tmhd)₄ are more resistant to urea formation and loss of crosslink density than materials reprocessed with Zr(acac)₄. Zr-based catalysts have also been proved to effectively reprocess commercial thermoset PU, both polyester and polyether PU.

### Materials and General Methods

Materials. Purchased reagents were procured from Sigma-Aldrich or Fisher Scientific. Lupranate M diol, Pluracol 2090 triol, and Pluracol 6601 diol were provided by BASF (Wyandotte, MI). Polyols were dried at 90° C. under 20 mTorr vacuum for at least 30 minutes prior to use for film or foam synthesis. All other reagents were used without further purification unless otherwise specified. Dichloromethane (CH₂Cl₂) and toluene were purchased from Fisher Scientific and purified using a custom-built alumina-column based solvent purification system.

Instrumentation. Infrared spectra were recorded on a Thermo Nicolet iS10 equipped with a ZnSe ATR attachment. Spectra were uncorrected.

Differential scanning calorimetry (DSC) was performed on a TA Instruments DSC250 Differential Scanning calorimeter. Samples (5-10 mg) were heated at a rate of 10° C./min to at least 150° C. to erase thermal history, cooled to −80° C. at 10° C./min, and then heated to at least 120° C. All data shown are taken from the second heating ramp. The glass transition temperature (T_{g}) was calculated from the maximum value of the derivative of heat flow with respect to temperature.

Dynamic mechanical thermal analysis (DMTA) was performed on a TA Instruments RSA-G2 analyzer (New Castle, DE) using rectangular (ca. 0.75 mm (T)×5 mm (W)×20 mm (L) and a gauge length of 10 mm). The axial force was adjusted to 0 N and a strain adjust of 30% was set with a minimum strain of 0.05%, a maximum strain of 5%, and a maximum force of 1 N in order to prevent the sample from buckling or going out of the specified strain. Furthermore, a force tracking mode was set such that the axial force was twice the magnitude of the oscillation force. A temperature ramp was then performed from 30° C. to 160° C. at a rate of 5° C./min, with an oscillating strain of 0.05% and an angular frequency of 6.28 rad s⁻¹ (1 Hz). The T_{g} was calculated from the maximum value of the loss modulus (E″).

Stress relaxation analysis (SRA) was performed on a TA Instruments RSA-III analyzer (New Castle, DE) using rectangular films (ca. 1.0 mm (T)×4 mm (W)×5 mm (L) and a Gauge length of 9 mm). The SRA experiments were performed with strain control at specific temperature (160° C.). The samples were allowed to equilibrate at this temperature for approximately 2-5 minutes, after which the axial force was then adjusted to 0 N. Each sample was then subjected to an instantaneous 5% strain. The stress decay was monitored, while maintaining a constant strain (5%), until the stress relaxation modulus had relaxed to at least 37% (1/e) of its initial value. This was performed three consecutive times for each sample. The activation energy (Eₐ) was determined using the methodology in literature.

Twin-screw extrusion was performed with a Thermo Scientific HAAKE MiniLab 3 Micro Compounder. All samples were directly flushed out of the extruder at a screw speed of 50 rotations per minute and 200° C. Residence time in the extruder was approximately 1 minute. Extrudates were passed through a rectangular die approximately 4 mm wide and 1 mm thick, resulting in a continuous film.

Cryogenic milling was performed with a RETSCH CryoMill. All samples were milled for two cryogenic cycles for approximately 10 min each cycle (actual grinding duration is 4 min) at a frequency of 30 Hz.

Inductively Coupled Plasma-Optical Emission Spectroscopy (ICP-OES) was performed by Robertson Microlit Analytical Testing Lab (Ledgewood, NJ). P, Zr and/or Sn content was assessed in the samples. Standard ICP-OES procedures, provided in a technical bulletin from Robertson Microlit, were then performed in triplicate. In this procedure for percent level determinations, a sample quantity with an estimated 10-50 ppm of the element(s) of interest was loaded into a digestion flask along with a digestion acid. The sample was then heated until fully digested, cooled, quantitatively transferred to a suitable volumetric flask, and diluted with DI water to reach the desired final concentration. Corresponding blank solutions and “reagent spike” solutions (if necessary) were prepared. Additional details can be accessed through contacting Robertson Microlit.

### Synthetic Procedures.

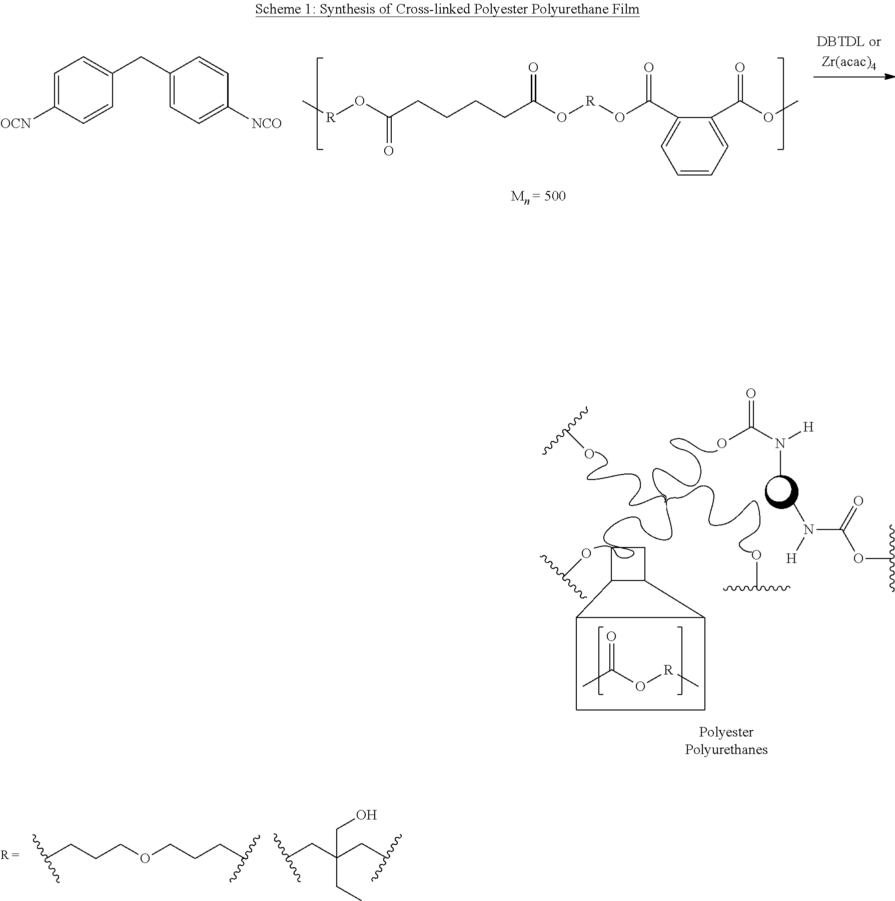

Synthesis of Crosslinked Polyester Polyurethane Films Containing Reprocessing Catalysts: In a 20 mL vial, polyol 1 (3.6 g, 18 mmol-OH), TNPP (0.03 g, 0.5 wt % of total film) and catalyst were dissolved in dry DCM and vortexed until completely dissolved. Catalyst was either DBTDL at 0.25, 0.50, or 1.0 mol % per carbamate (28, 55, or 110 mg) or Zr(acac)₄ at 0.25, 0.50, or 1.0 mol % per carbamate (21 mg, 42 mg, or 85 mg). MDI (2.25 g, 9 mmol) was added to the polyol and catalyst solution and vortexed until completely dissolved. The resulting solution was cast in a 150 mL aluminum pan and left for 24 h to gel. Films were then postcured for 48 hours in a vacuum oven at 90° C. under 20 mTorr vacuum.

This same procedure was attempted to synthesize films with 0.5 wt % TNPP and Zr(tmhd)₄ at 0.25, 0.35, 0.50, 0.75, and 1.0 mol %. However, these films were inhomogeneous, highly brittle, and phase segregated, especially at higher catalyst loadings, and were not suitable for characterization.

Synthesis of Films Without Added Catalyst: In a 20 mL vial, polyol 1 (3.6 g, 18 mmol —OH) was dissolved in 8.0 mL dry toluene. MDI (2.25 g, 9 mmol) was added to the solution and vortexed until completely dissolved. The resulting solution was cast in a 150 mL aluminum pan, covered with aluminum foil, and heated at 60° C. for 18 h on a hot plate to facilitate gelling. Films were then postcured in a vacuum oven at 90° C. under 20 mTorr vacuum at 100° C. for 4 h, 140° C. for 2 h, and 60° C. for 12 h.

Synthesis of Crosslinked Polyester Polyurethane Foam: In a plastic cup, poly [trimethylolpropane/di(propylene glycol)-alt-adipic acid/phthalic anhydride] polyol (10 g, 50 mmol-OH), blowing agent isopentane (300 mg), and dibutyltin dilaurate (111 mg, 0.02 mol % with respect to MDI). Ground solid 4,4′-methylenebis(phenyl isocyanate) (MDI) (6.26 g, 25.0 mmol) was added and mixed vigorously. The mixture was allowed to sit for 1 h to gel and rise. After 24 h, the resulting polymer foam was cured at 150° C. for 1 hour in an oven to ensure full cross-linking.

PU Film: FT-IR (solid, ATR)₃₃₀₇ (N—H stretch), 2917, 1708 (C═O stretch), 1597, 1529 (N—H deformation), 1457, 1412, 1377, 1308, 1219, 1066, 1017, 816, 766 cm⁻¹.

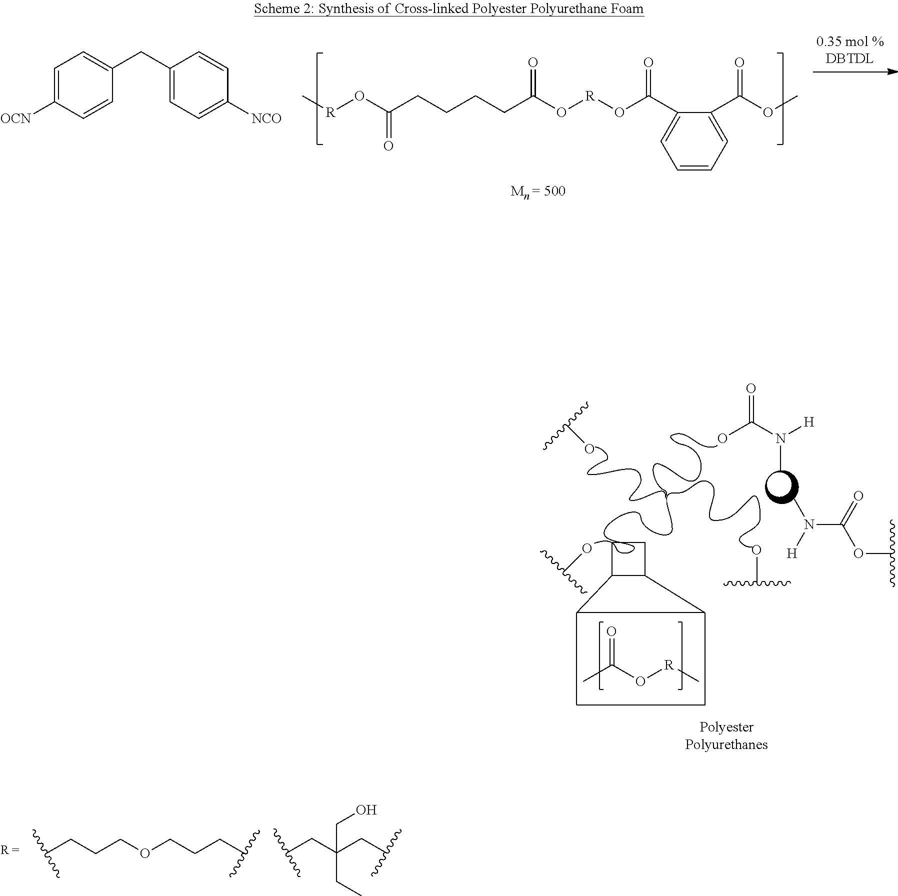

Synthesis of Crosslinked Polyester Polyurethane Foam Containing Reprocessing Catalysts: In a plastic cup, polyol 1 (10 g, 50 mmol-OH), blowing agent isopentane (300 mg), and DBTDL (111 mg, 0.02 mol % with respect to MDI). Ground solid MDI (6.26 g, 25.0 mmol) was added and mixed vigorously. The mixture was allowed to sit for 1 h to gel and rise. After 24 h, the resulting polymer foam was cured at 150° C. for 1 hour in an oven to ensure full cross-linking.

Foams synthesized from commercial polyols and isocyanates provided by BASF used the same procedure as above. Polyester PU foams were synthesized with Pluracol 6601 diol (13.3 g, ˜3 kg/mol), Lupranate M20 (4.05 g, 360 g/mol, ˜2.7 isocyanates per molecule), DBTDL (37 mg), and isopentane (100 mg). Polyether PU foams were synthesized with Pluracol 2090 triol (12.34 g, ˜4.8 g/mol), MDI (2.09 g, 250 g/mol, 2 isocyanates per molecule), DBTDL (37 mg), and isopentane (100 mg). There were no variations to the procedure used with polyol 1, except that MDI was ground more finely with mortar and pestle to synthesize the polyether PU foam.

PU Foam: FT-IR (solid, ATR) 2932, 1723 (C—O stretch), 1596, 1530 (N—H deformation), 1511, 1456, 1412, 1377, 1307, 1219, 1124, 1063, 1017, 816, 767, 745, 705 cm⁻¹.

Post-synthetic introduction of catalyst to model PU film or foam: Polymer foam (10.0 g) was suspended in CH₂Cl₂ (100 mL). A catalyst [DBTDL, Zr(acac)₄, or Zr(tmhd)₄] was added to the suspension to obtain the desired solution concentration (10, 20, or 30 mg/mL). The resulting suspension was stirred overnight, after which the solvent-swollen polymer was isolated by filtration and dried in a vacuum oven at 90° C. at 20 m Torr for 24 h.

TABLE 6
Weight percent of P, Sn, or Zr measured in PU foam using inductively coupled plasma
- optical emission spectroscopy and corresponding catalyst mass in each sample.
Catalyst was introduced to all samples through a solvent-assisted method.

| | Solution | | | |
|---|---|---|---|---|
| | concentration | | | DBTDL in foam |
| Catalyst | (mg/mL) | wt % P | wt % Sn | (g) |
| DBTDL | 10 | 0.06 ± 0.02 | 0.45 ± 0.01 | 0.24 |
| DBTDL | 20 | 0.02 ± 0.01 | 1.07 ± 0.04 | 0.57 |
| DBTDL | 30 | 0.02 ± 0.01 | 1.76 ± 0.02 | 0.94 |

| | Solution | Mass of foam | | | | Zr(acac)₄ |
|---|---|---|---|---|---|---|
| | concentration | and Zr(acac)₄ | | | | in foam |
| Catalyst | (mg/mL) | in samples | wt % P | wt % Sn | wt % Zr | (g) |
| Zr(acac)₄ | 10 | 9 g foam, | 0.02 ± | 0.12 ± | 1.62 ± | 0.87 |
| | | 1 g Zr(acac)₄ | 0.01 | 0.01 | 0.01 | |
| Zr(acac)₄ | 20 | 8 g foam, | 0.01 ± | 0.11 ± | 2.53 ± | 1.35 |
| | | 2 g Zr(acac)₄ | 0.01 | 0.01 | 0.02 | |
| Zr(acac)₄ | 30 | 7 g foam, | 0.01 ± | 0.11 ± | 3.10 ± | 1.66 |
| | | 3 g Zr(acac)₄ | 0.01 | 0.01 | 0.05 | |
| | Solution | Mass of foam | | | | Zr(tmhd)₄ |
| | concentration | and Zr(tmhd)₄ | | | | in foam |
| Catalyst | (mg/mL) | in samples | wt % P | wt % Sn | wt % Zr | (g) |
| Zr(tmhd)₄ | 10 | 9 g foam, | 0.01 ± | 0.10 ± | 0.50 ± | 0.45 |
| | | 1 g Zr(tmhd)₄ | 0.01 | 0.01 | 0.01 | |
| Zr(tmhd)₄ | 20 | 8 g foam, | 0.01 ± | 0.09 ± | 1.03 ± | 0.93 |
| | | 2 g Zr(tmhd)₄ | 0.01 | 0.01 | 0.04 | |
| Zr(tmhd)₄ | 30 | 7 g foam, | 0.01 ± | 0.10 ± | 1.27 ± | 1.15 |
| | | 3 g Zr(tmhd)₄ | 0.01 | 0.01 | 0.08 | |

TABLE 7
Crosslink density and T_{g} by DSC of samples reprocessed with DBTDL, Zr(acac)₄,
or Zr(tmhd)₄ for multiple cycles with Zr-based catalysts.

| Catalyst | Density (g/cm³) | G′ (MPa)* | M_{c} (g/mol)⁺ | q (mol/cm³)^{#} | T_{g} (° C.) |
|---|---|---|---|---|---|
| DBTDL | 1.05 | 0.316 | 10300 | 0.079 | 45.1 |
| cycle 1 | | | | | |
| Zr(acac)₄ | 0.100 | 0.362 | 8540 | 0.095 | 14.1 |
| cycle 1 | | | | | |
| Zr(acac)₄ | 1.06 | 0.730 | 4500 | 0.18 | 14.5 |
| cycle 2 | | | | | |
| Zr(acac)₄ | 1.11 | 0.978 | 3510 | 0.23 | 7.28 |
| cycle 3 | | | | | |
| Zr(acac)₄ | 0.730 | 1.42 | 1600 | 0.51 | 3.13 |
| cycle 4 | | | | | |
| Zr(tmhd)₄ | 1.02 | 0.904 | 3480 | 0.23 | 49.5 |
| cycle 1 | | | | | |
| Zr(tmhd)₄ | 1.09 | 1.01 | 3350 | 0.24 | 40.2 |
| cycle 2 | | | | | |
| Zr(tmhd)₄ | 1.01 | 1.12 | 2770 | 0.29 | 39.0 |
| cycle 3 | | | | | |
| Zr(tmhd)₄ | 1.04 | 1.90 | 1690 | 0.48 | 33.5 |
| cycle 4 | | | | | |

*G′ is the storage modulus of the polymer derived from DMTA in the rubbery plateau region at 100° C.
⁺M_{c} is the molecular weight between crosslinks, and calculated it is calculated through the
$equation . M = \frac{RTd}{{G}_{rubbery}^{′}} , where R is the universal gas constant , T is the absolute temperature , d is$ polymer density (g/cm³), and G′ is the previously calculated storage modulus of the polymer in the rubbery plateau region.
^{#}q is the crosslinking density of the polymer, and it is calculated by dividing the molecular weight of the monomer by crosslinking density Mc.

TABLE 8
Characterization table of model PU polyester foams reprocessed
with DBTDL, Zr(acac)₄, or Zr(tmhd)₄ for comparison purposes.
All foam samples prepared through the solvent-assisted
method were soaked in catalyst-containing solutions
at a concentration of 30 mg/mL in DCM.

| | Catalyst | τ* at | | | E′ at |
|---|---|---|---|---|---|
| Mol % | introduction | 160 C. ° | T_{g, DSC} | T_{g, DMTA} | 110° C. |
| catalyst | method | (C. °) | (C. °) | (C. °) | (MPa) |
| 6.0 mol % | Solvent- | 29 | 46 | — | — |
| DBTDL | assisted | | | | |
| 11.4 mol % | Solvent- | 17 | 14 | 33 | 3.1 E 8 |
| Zr(acac)₄ | assisted | | | | |
| 5.7 mol % | Solvent- | 49 | 49 | 52 | 1.7 E 8 |
| Zr(tmhd)₄ | assisted | | | | |
| 2.0 mol % | Cryomill | 54 | 32 | 47 | 2.8 E 7 |
| Zr(acac)₄ | | | | | |

### REFERENCES

1 Szycher, M. Szycher's Handbook of Polyurethanes. 1112.
2 Liang, C.; Gracida-Alvarez, U. R.; Gallant, E. T.; Gillis, P. A.; Marques, Y. A.; Abramo, G. P.; Hawkins, T. R.; Dunn, J. B. Material Flows of Polyurethane in the United States. Environ. Sci. Technol. 2021, 55, 14215-14224. https://doi.org/10.1021/acs.est. 1c03654.
3 Kulkarni, G. S. 1-Introduction to Polymer and Their Recycling Techniques. In Recycling of Polyurethane Foams; Thomas, S., Rane, A. V., Kanny, K., V. k., A., Thomas, M. G., Eds.; Plastics Design Library; William Andrew Publishing, 2018; pp 1-16. https://doi.org/10.1016/B978-0-323-51133-9.00001-2.
4 Zia, K. M.; Bhatti, H. N.; Ahmad Bhatti, I. Methods for Polyurethane and Polyurethane Composites, Recycling and Recovery: A Review. React. Funct. Polym. 2007, 67, 675-692. https://doi.org/10.1016/j.reactfunctpolym.2007.05.004.
5 Kloxin, C. J.; Scott, T. F.; Adzima, B. J.; Bowman, C. N. Covalent Adaptable Networks (CANs): A Unique Paradigm in Cross-Linked Polymers. Macromolecules 2010, 43, 2643-2653. https://doi.org/10.1021/ma902596s.
6 J. Kloxin, C.; N. Bowman, C. Covalent Adaptable Networks: Smart, Reconfigurable and Responsive Network Systems. Chem. Soc. Rev. 2013, 42, 7161-7173. https://doi.org/10.1039/C3CS60046G.
7 McBride, M. K.; Worrell, B. T.; Brown, T.; Cox, L. M.; Sowan, N.; Wang, C.; Podgorski, M.; Martinez, A. M.; Bowman, C. N. Enabling Applications of Covalent Adaptable Networks. Annu. Rev. Chem. Biomol. Eng. 2019, 10, 175-198. https://doi.org/10.1146/annurev-chembioeng-060718-030217.
8 Bowman, C.; Du Prez, F.; Kalow, J. Introduction to Chemistry for Covalent Adaptable Networks. Polym. Chem. 2020, 11, 5295-5296. https://doi.org/10.1039/DOPY90102D.
9 Montarnal, D.; Capelot, M.; Tournilhac, F.; Leibler, L. Silica-Like Malleable Materials from Permanent Organic Networks. Science 2011, 334, 965-968. https://doi.org/10.1126/science.1212648.
10 Huang, L.; Yang, Y.; Niu, Z.; Wu, R.; Fan, W.; Dai, Q.; He, J.; Bai, C. Boronic Ester Bonds Crosslinked Vitrimer Elastomers with Mechanical Robustness, Shape Memory, Self-Healing and Recyclability Properties. Compos. Sci. Technol. 2022, 228, 109621. https://doi.org/10.1016/j.compscitech.2022.109621.
11 Zhang, V.; Kang, B.; Accardo, J. V.; Kalow, J. A. Structure-Reactivity-Property Relationships in Covalent Adaptable Networks. J. Am. Chem. Soc. 2022, 144, 22358-22377. https://doi.org/10.1021/jacs.2c08104.
12 Cromwell, O. R.; Chung, J.; Guan, Z. Malleable and Self-Healing Covalent Polymer Networks through Tunable Dynamic Boronic Ester Bonds. J. Am. Chem. Soc. 2015, 137, 6492-6495. https://doi.org/10.1021/jacs.5b03551.
13 Liu, Z.; Ma, Y.; Xiang, Y.; Shen, X.; Shi, Z.; Gao, J. Integrating Boronic Esters and Anthracene into Covalent Adaptable Networks toward Stimuli-Responsive Elastomers. Polymers 2022, 14, 1104. https://doi.org/10.3390/polym14061104.
14 Willocq, B.; Khelifa, F.; Brancart, J.; Van Assche, G.; Dubois, Ph.; Raquez, J.-M. One-Component Diels-Alder Based Polyurethanes: A Unique Way to Self-Heal. RSC Adv 2017, 7, 48047-48053. https://doi.org/10.1039/C7RA09898G.
15 Li, L.; Qin, X.; Mei, H.; Liu, L.; Zheng, S. Reprocessed and Shape Memory Networks Involving Poly(Hydroxyl Ether Ester) and Polydimethylsiloxane through Diels-Alder Reaction. Eur. Polym. J. 2021, 160, 110811. https://doi.org/10.1016/j.eurpolymj.2021.110811.
16 Snyder, R. L.; Fortman, D. J.; De Hoe, G. X.; Hillmyer, M. A.; Dichtel, W. R. Reprocessable Acid-Degradable Polycarbonate Vitrimers. Macromolecules 2018, 51, 389-397. https://doi.org/10.1021/acs.macromol.7b02299.
17 Lei, Z. Q.; Xiang, H. P.; Yuan, Y. J.; Rong, M. Z.; Zhang, M. Q. Room-Temperature Self-Healable and Remoldable Cross-Linked Polymer Based on the Dynamic Exchange of Disulfide Bonds. Chem. Mater. 2014, 26, 2038-2046. https://doi.org/10.1021/cm4040616.
18 Fenimore, L. M.; Chen, B.; Torkelson, J. M. Simple Upcycling of Virgin and Waste Polyethylene into Covalent Adaptable Networks: Catalyst-Free, Radical-Based Reactive Processing with Dialkylamino Disulfide Bonds. J. Mater. Chem. A 2022, 10, 24726-24745. https://doi.org/10.1039/D2TA06364F.
19 Debsharma, T.; Amfilochiou, V.; Wróblewska, A. A.; De Baere, I.; Van Paepegem, W.; Du Prez, F. E. Fast Dynamic Siloxane Exchange Mechanism for Reshapable Vitrimer Composites. J. Am. Chem. Soc. 2022, 144, 12280-12289. https://doi.org/10.1021/jacs.2c03518.
20 Yan, Q.; Zhao, L.; Cheng, Q.; Zhang, T.; Jiang, B.; Song, Y.; Huang, Y. Self-Healing Polysiloxane Elastomer Based on Integration of Covalent and Reversible Networks. Ind. Eng. Chem. Res. 2019, 58, 21504-21512. https://doi.org/10.1021/acs.iecr.9b04355.
21 Yan, P.; Zhao, W.; Fu, X.; Liu, Z.; Kong, W.; Zhou, C.; Lei, J. Multifunctional Polyurethane-Vitrimers Completely Based on Transcarbamoylation of Carbamates: Thermally-Induced Dual-Shape Memory Effect and Self-Welding. RSC Adv. 2017, 7, 26858-26866. https://doi.org/10.1039/C7RA01711A.
22 Shi, J.; Zheng, T.; Zhang, Y.; Guo, B.; Xu, J. Reprocessable Cross-Linked Polyurethane with Dynamic and Tunable Phenol-Carbamate Network. ACS Sustain. Chem. Eng. 2020, 8, 1207-1218. https://doi.org/10.1021/acssuschemeng.9b06435.
23 Sheppard, D. T.; Jin, K.; Hamachi, L. S.; Dean, W.; Fortman, D. J.; Ellison, C. J.; Dichtel, W. R. Reprocessing Postconsumer Polyurethane Foam Using Carbamate Exchange Catalysis and Twin-Screw Extrusion. ACS Cent. Sci. 2020, 6, 921-927. https://doi.org/10.1021/acscentsci.0c00083.
24 Kemona, A.; Piotrowska, M. Polyurethane Recycling and Disposal: Methods and Prospects. Polymers 2020, 12, 1752. https://doi.org/10.3390/polym12081752.
25 Fortman, D. J.; Sheppard, D. T.; Dichtel, W. R. Reprocessing Cross-Linked Polyurethanes by Catalyzing Carbamate Exchange. Macromolecules 2019, 52, 6330-6335. https://doi.org/10.1021/acs.macromol.9b01134.
26 Jin, M.; Song, P.; Li, N.; Li, X.; Chen, J. A Plastic Stabilizer Dibutyltin Dilaurate Induces Subchronic Neurotoxicity in Rats☆. Neural Regen. Res. 2012, 7, 2213-2220. https://doi.org/10.3969/j.issn.1673-5374.2012.028.007.
27 Elling, B. R.; Dichtel, W. R. Reprocessable Cross-Linked Polymer Networks: Are Associative Exchange Mechanisms Desirable? ACS Cent. Sci. 2020, 6, 1488-1496. https://doi.org/10.1021/acscentsci.0c00567.
28 Meng, F.; Pritchard, R. H.; Terentjev, E. M. Stress Relaxation, Dynamics, and Plasticity of Transient Polymer Networks. Macromolecules 2016, 49, 2843-2852. https://doi.org/10.1021/acs.macromol.5b02667.
29 Zhang, Y.; Zhang, L.; Yang, G.; Yao, Y.; Wei, X.; Pan, T.; Wu, J.; Tian, M.; Yin, P. Recent Advances in Recyclable Thermosets and Thermoset Composites Based on Covalent Adaptable Networks. J. Mater. Sci. Technol. 2021, 92, 75-87. https://doi.org/10.1016/j.jmst.2021.03.043.
30 Chen, X.; Hu, S.; Li, L.; Torkelson, J. M. Dynamic Covalent Polyurethane Networks with Excellent Property and Cross-Link Density Recovery after Recycling and Potential for Monomer Recovery. ACS Appl. Polym. Mater. 2020, 2, 2093-2101. https://doi.org/10.1021/acsapm.0c00378.
31 Khan, A.; Naveed, M.; Rabnawaz, M. Melt-Reprocessing of Mixed Polyurethane Thermosets. Green Chem. 2021, 23, 4771-4779, https://doi.org/10.1039/DIGC01232K.
32 Bandegi, A.; Montemayor, M.; Manas-Zloczower, I. Vitrimerization of Rigid Thermoset Polyurethane Foams: A Mechanochemical Method to Recycle and Reprocess Thermosets. Polym. Adv. Technol. 2022, 33, 3750-3758. https://doi.org/10.1002/pat.5827.
33 Zirconium(IV) acetylacetonate; CAS RN: 17501-44-9; 338001; rev. 6; Sigma-Aldrich: St. Louis, MO, Jul. 20, 2023.
34 Zirconium tetrakis(2,2,6,6-tetramethyl-3,5-heptanedionate); CAS RN: 18865-74-2; 478865; rev. 6; Sigma-Aldrich: St. Louis, MO, Mar. 25, 2023.
35 Jones, M. D. In Sustainable Catalysis with Non-endangered Metals, Part 1; Royal Society of Chemistry, 2016; pp 199-215. https://doi.org/10_1039/9781782622116
36 Sardon, H.; Irusta, L.; Fernández-Berridi, M. J. Synthesis of Isophorone Diisocyanate (IPDI) Based Waterborne Polyurethanes: Comparison between Zirconium and Tin Catalysts in the Polymerization Process. Prog. Org. Coat. 2009, 66, 291-295. https://doi.org/10.1016/j.porgcoat.2009.08.005.
37 Dobrzynski, P.; Kasperczyk, J.; Janeczek, H.; Bero, M. Synthesis of Biodegradable Copolymers with the Use of Low Toxic Zirconium Compounds. 1. Copolymerization of Glycolide with L-Lactide Initiated by Zr(Acac)₄. Macromolecules 2001, 34, 5090-5098. https://doi.org/10.1021/ma0018143.
38 Nandurkar, N. S.; Patil, D. S.; Bhanage, B. M. Ultrasound Assisted Synthesis of Metal-1,3-Diketonates. Inorg. Chem. Commun. 2008, 11, 733-736. https://doi.org/10.1016/j.inoche.2008.03.014.
39 Han, C.; Porco. Synthesis of Carbamates and Ureas Using Zr(IV)-Catalyzed Exchange Processes. Org. Lett. 2007, 9, 1517-1520. https://doi.org/10.1021/010702728.
40 Petrak, S.; Shadurka, V.; Binder, W. H. Cleavage of Blocked Isocyanates within Amino-Type Resins: Influence of Metal Catalysis on Reaction Pathways in Model Systems. Prog. Org. Coat. 2009, 66, 296-305. https://doi.org/10.1016/j.porgcoat.2009.08.006.
41 Blank, W. J.; He, Z. A.; Hessell, E. T. Catalysis of the Isocyanate-Hydroxyl Reaction by Non-Tin Catalysts. Prog. Org. Coat. 1999, 35, 19-29. https://doi.org/10.1016/S0300-9440 (99)00006-5.
42 Yang, P. F.; Li, T. D. Urethane Reaction Kinetics of Butanediols Catalyzed by Zr(Acac)₄. J. Appl. Polym. Sci. 2013, 129, 2399-2403. https://doi.org/10.1002/app.38978.
43 Debnath, S.; Tiwary, S. K.; Ojha, U. Dynamic Carboxylate Linkage Based Reprocessable and Self-Healable Segmented Polyurethane Vitrimers Displaying Creep Resistance Behavior and Triple Shape Memory Ability. ACS Appl. Polym. Mater. 2021, 3, 2166-2177. https://doi.org/10.1021/acsapm. 1c00199.
44 Li, J.; Ning, Z.; Yang, W.; Yang, B.; Zeng, Y. Hydroxyl-Terminated Polybutadiene-Based Polyurethane with Self-Healing and Reprocessing Capabilities. ACS Omega 2022, 7, 10156-10166. https://doi.org/10.1021/acsomega.1c06416.
45 Gao, W.; Bie, M.; Quan, Y.; Zhu, J.; Zhang, W. Self-Healing, Reprocessing and Sealing Abilities of Polysulfide-Based Polyurethane. Polymer 2018, 151, 27-33. https://doi.org/10.1016/j.polymer.2018.07.047.
46 Swartz, J. L.; Sheppard, D. T.; Haugstad, G.; Dichtel, W. R. Blending Polyurethane Thermosets Using Dynamic Urethane Exchange. Macromolecules 2021, 54, 11126-11133. https://doi.org/10.1021/acs.macromol.1c01910.
47 Peterson, G. I.; Ko, W.; Hwang, Y.-J.; Choi, T.-L. Mechanochemical Degradation of Amorphous Polymers with Ball-Mill Grinding: Influence of the Glass Transition Temperature. Macromolecules 2020, 53, 7795-7802. https://pubs.acs.org/doi/10.1021/acs.macromol.0c01510

We claim:

1. A method for reprocessing a crosslinked polyurethane, the method comprising mechanically processing the crosslinked polyurethane, mixing the mechanically processed crosslinked polyurethane with a solid polyurethane exchange catalyst, heating the mixture to an effective bond-exchange temperature, and applying mechanical force to the mixture for an effective bond-exchange time.

2. The method of claim 1, wherein the crosslinked polyurethane is mechanically processed with the solid polyurethane exchange catalyst.

3. The method of any one of claims 1-2,
(i) wherein the solid polyurethane exchange catalyst comprises Zr, Bi, Fe, Ti, Hf, Al, Zn, Cu, Ni, Co, Mn, V, Sc, Y, Ce, Mo, or Sn and a ligand coordinated with the metal atom, optionally wherein the solid polyurethane exchange catalyst comprises Zr (e.g., Zr(acac)₄ or Zr(tmdh)₄); or
(ii) wherein mechanically processing the crosslinked polyurethane comprises milling the crosslinked polyurethane, optionally wherein the crosslinked polyurethane is mechanically processed at a temperature less than 20° C. or at a temperature between −200° C. and 0° C.; or
(iii) wherein the mechanically processed crosslinked polyurethane is mixed with less than 5 mol % solid polyurethane exchange catalyst per carbamate; or
(iv) wherein an antioxidant composition comprising the crosslinked polyurethane and an antioxidant is mechanically processed, optionally wherein the antioxidant is tris(nonylphenyl) phosphite; or
(v) wherein the mixture is dried under vacuum at a drying temperature prior to heating the mixture to the effective bond-exchange temperature; or
(vi) wherein the crosslinked polyurethane is a crosslinked polyurethane foam; or
any combination thereof.

4. The method of claim 3, wherein the solid polyurethane exchange catalyst comprises Zr, Bi, Fe, Ti, Hf, Al, Zn, Cu, Ni, Co, Mn, V, Sc, Y, Ce, Mo, or Sn and a ligand coordinated with the metal atom.

5. The method of claim 4, wherein the solid polyurethane exchange catalyst comprises Zr.

6. The method of claim 5, wherein the solid polyurethane exchange catalyst is Zr(acac)₄ or Zr(tmdh)₄.

7. The method of claim 3, wherein mechanically processing the crosslinked polyurethane comprises milling the crosslinked polyurethane.

8. The method of claim 7, wherein the crosslinked polyurethane is mechanically processed at a temperature less than 20° C.

9. The method of claim 7, wherein the crosslinked polyurethane is mechanically processed at the temperature between −200° C. and 0° C.

10. The method of claim 3, wherein the mechanically processed crosslinked polyurethane is mixed with less than 5 mol % solid polyurethane exchange catalyst per carbamate.

11. The method of claim 3, wherein the antioxidant composition comprising the crosslinked polyurethane and the antioxidant is mechanically processed.

12. The method of claim 11, wherein the antioxidant is tris(nonylphenyl) phosphite.

13. The method of claim 3, wherein the mixture is dried under vacuum at the drying temperature prior to heating the mixture to the effective bond-exchange temperature.

14. The method of claim 3, wherein the crosslinked polyurethane is a crosslinked polyurethane foam.

15. The method of claim 3, wherein the method comprises any 2, any 3, any 4, any 5, or all 6 of (i)-(vi).

16. A polyurethane composition comprising the mechanically processed crosslinked polyurethane according to claim 1 and a solid polyurethane exchange catalyst.

17. The polyurethane composition of claim 16, wherein the solid polyurethane exchange catalyst comprises Zr, Bi, Fe, Ti, Hf, Al, Zn, Cu, Ni, Co, Mn, V, Sc, Y, Ce, Mo, or Sn and a ligand coordinated with the metal atom.

18. The polyurethane composition of claim 17, wherein the solid polyurethane exchange catalyst comprises Zr.

19. The polyurethane composition of claim 18, wherein the solid polyurethane exchange catalyst is Zr(acac)₄ or Zr(tmdh)₄.

20. The polyurethan composition of any one of claims 16-19, wherein the mechanically processed crosslinked polyurethane is mixed with less than 5 mol % solid polyurethane exchange catalyst per carbamate.

21. The polyurethane composition of any one of claims 16-19 further comprising an antioxidant.

22. The polyurethane composition of claim 21, wherein the antioxidant is tris(nonylphenyl) phosphite.

23. The polyurethane composition of any one of claims 21-22, wherein the mechanically processed crosslinked polyurethane is mixed with less than 5 mol % solid polyurethane exchange catalyst per carbamate.

24. A method for reprocessing a crosslinked polyurethane, the method comprising heating a polyurethane exchange catalyst and an antioxidant composition, the antioxidant composition comprising the crosslinked polyurethane and an antioxidant, to an effective bond-exchange temperature and applying mechanical force to the polyurethane exchange catalyst and the antioxidant composition for an effective bond-exchange time, optionally wherein the antioxidant is tris(nonylphenyl) phosphite.

25. The method of claim 24, wherein the polyurethane exchange catalyst is a solid and mixed with the polyurethane composition prior to heating to the effective bond-exchange temperature.

26. The method of claim 24, wherein a polyurethane exchange catalyst solution comprising the polyurethane exchange catalyst is permeated within the crosslinked polyurethane prior to heating to the effective bond-exchange temperature.

27. The method of any one of claims 24-26,
(i) wherein the polyurethane exchange catalyst comprises Zr, Bi, Fe, Ti, Hf, Al, Zn, Cu, Ni, Co, Mn, V, Sc, Y, Ce, Mo, or Sn and a ligand coordinated with the metal atom, optionally wherein the polyurethane exchange catalyst comprises Zr(e.g., Zr(acac)₄ or Zr(tmdh)₄); or
(ii) wherein the polyurethane exchange catalyst is a solid, the crosslinked polyurethane is mechanically processed, and the solid polyurethane exchange catalyst and the mechanically processed crosslinked polyurethane is mixed prior to heating to the effective bond-exchange temperature, optionally wherein the crosslinked polyurethane is mechanically processed at a temperature less than 20° C. or at a temperature between −200° C. and 0° C.; or
(iii) wherein the antioxidant is tris(nonylphenyl) phosphite; or
(iv) wherein the crosslinked polyurethane is mixed with less than 5 mol % polyurethane exchange catalyst per carbamate; or
(v) wherein the crosslinked polyurethane is a crosslinked polyurethane foam; or
any combination thereof.

28. The method of claim 27, wherein the polyurethane exchange catalyst comprises Zr, Bi, Fe, Ti, Hf, Al, Zn, Cu, Ni, Co, Mn, V, Sc, Y, Ce, Mo, or Sn and a ligand coordinated with the metal atom.

29. The method of claim 28, wherein the polyurethane exchange catalyst comprises Zr.

30. The method of claim 29, wherein the polyurethane exchange catalyst is Zr(acac)₄ or Zr(tmdh)₄.

31. The method of claim 27, wherein the polyurethane exchange catalyst is a solid, the crosslinked polyurethane is mechanically processed, and the solid polyurethane exchange catalyst and the mechanically processed crosslinked polyurethane is mixed prior to heating to the effective bond-exchange temperature.

32. The method of claim 31, wherein the crosslinked polyurethane is mechanically processed at a temperature less than 20° C.

33. The method of claim 31, wherein the crosslinked polyurethane is mechanically processed at a temperature between −200° C. and 0° C.

34. The method of claim 27, wherein the antioxidant is tris(nonylphenyl) phosphite.

35. The method of claim 27, wherein the crosslinked polyurethane is mixed with less than 5 mol % polyurethane exchange catalyst per carbamate.

36. The method of claim 27, wherein the crosslinked polyurethane is the crosslinked polyurethane foam.

37. The method of claim 27, wherein the method comprises any 2, any 3, any 4, or all 5 of (i)-(v).

38. A polyurethane composition comprising the crosslinked polyurethane according to claim 24, an antioxidant, and a polyurethane exchange catalyst permeated within the crosslinked polyurethane.

39. The polyurethane composition of claim 38, wherein the antioxidant is tris(nonylphenyl) phosphite.

40. The polyurethane composition of any one of claims 38-39, wherein the polyurethane exchange catalyst comprises Zr, Bi, Fe, Ti, Hf, Al, Zn, Cu, Ni, Co, Mn, V, Sc, Y, Ce, Mo, or Sn and a ligand coordinated with the metal atom.

41. The polyurethane composition of claim 40, wherein the polyurethane exchange catalyst comprises Zr.

42. The polyurethane composition of claim 41, wherein the catalyst is Zr(acac)₄ or Zr(tmhd)₄.
